(19) United States
(12) Patent Application Publication
(10) Pub. No.: US 2016/0260178 A1
(43) Pub. Date: Sep. 8, 2016

(54) COMMODITY MANAGEMENT SYSTEM, INFORMATION PROCESSING APPARATUS AND TERMINAL DEVICE FOR MANAGING COMMODITY

(71) Applicant: TOSHIBA TEC KABUSHIKI KAISHA, Tokyo (JP)

(72) Inventors: Katsuhito MOCHIZUKI, Tagata Shizuoka (JP); Mahina NAKAMURA, Mitaka Tokyo (JP); Yumiko OKUMA, Nakano Tokyo (JP); Yasutsugu SASAKI, Yokohama Kanagawa (JP)

(21) Appl. No.: 15/057,778

(22) Filed: Mar. 1, 2016

(30) Foreign Application Priority Data
Mar. 2, 2015 (JP) 2015-039912

(51) Int. Cl. G06Q 40/00; G06F 17/30

(52) U.S. Cl. CPC G06Q 40/12; G06F 17/30342

(57) ABSTRACT

According to an embodiment, a terminal device includes a display, an communication interface, a memory and a controller. The communication interface receives extended receipt information that identifies a commodity subject to a transaction and a classification data for classifying the commodity. The memory stores the extended receipt information, a commodity image data representing the commodity, and at least one of a plurality of screen data each representing a different possible virtual management location of the commodity. The controller determines a specific virtual management location of the commodity from the different possible virtual management locations based on the classification data, and controls the display to display the commodity image included in a screen based on the screen data corresponding to the determined specific virtual management location of the commodity.

### CROSS-REFERENCE TO RELATED APPLICATION

This application is based upon and claims the benefit of priority from Japanese Patent Application No. 2015-039912, filed Mar. 2, 2015, the entire contents of which are incorporated herein by reference.

### FIELD

Embodiments described herein relate generally to an information processing apparatus and a method for sorting a commodity.

### BACKGROUND

Conventionally, an electronic receipt system is known in which a receipt delivered to a customer is electronically transferred to a terminal of the customer from a store at the time of the settlement of commodities. Further, conventionally, a screen based on an electronic receipt is displayed on the terminal of the customer who receives the electronic receipt.

In this way, it is beneficial to the customer to be capable of confirming a purchased commodity by turning the receipt into electronic receipt information made into electronic data. Further, the introduction of the electronic receipt system is also beneficial to the introduced store as the consumption of receipt papers can be reduced.

However, according to the structure of conventional electronic receipt, printing contents printed on the paper receipt are generated as an electronic receipt. Thus, in the conventional electronic receipt, other contents which are not limited to the content on the paper receipt cannot be handled, and an operation carried out at the terminal side receiving the electronic receipt is limited in a range of the printing contents. For example, in a case of managing the purchased commodities, the purchased commodities are classified according to a storage location. However, in the conventional electronic receipt information, as there is no information for carrying out classification, the purchased commodities are sorted manually.

### DESCRIPTION OF THE DRAWINGS

FIG. 1 is a diagram exemplifying the structure of an electronic receipt system according to an embodiment;

FIG. 2 is a block diagram exemplifying the structure of a POS terminal;

FIG. 3 is a diagram exemplifying the data structure of an extended data file;

FIG. 4 is a block diagram exemplifying the structure of an electronic receipt server;

FIG. 5 is a block diagram exemplifying the structure of an electronic receipt management server;

FIG. 6 is a diagram schematically exemplifying the data structure of an electronic receipt management area;

FIG. 7 is a block diagram exemplifying the structure of a portable terminal;

FIG. 8 is a diagram exemplifying the data structure of a sorting condition file;

FIG. 9 is a block diagram exemplifying a functional section relating to an electronic receipt processing of the POS terminal;

FIG. 10 is a diagram schematically illustrating an example of receipt information;

FIG. 11 is a diagram schematically illustrating an example of electronic receipt information;

FIG. 12 is a diagram schematically illustrating an example of electronic receipt information added with extended data;

FIG. 13 is a flowchart exemplifying procedure of the electronic receipt processing of the POS terminal;

FIG. 14 is a block diagram exemplifying a functional section relating to an electronic receipt management processing and an information sending processing of the electronic receipt management server;

FIG. 15 is a flowchart exemplifying the procedures of the electronic receipt management processing and the information sending processing of the electronic receipt management server;

FIG. 16 is a block diagram exemplifying a functional section relating to an electronic receipt receiving processing and a purchased commodity management processing of the portable terminal;

FIG. 17 is a diagram illustrating an example of a purchased commodity management screen displayed on a display section of the portable terminal;

FIG. 18 is a diagram illustrating an example of a purchased commodity management screen displayed on the display section of the portable terminal;

FIG. 19 is a diagram illustrating an example of a purchased commodity management screen displayed on the display section of the portable terminal;

FIG. 20 is a diagram illustrating an example of a commodity details screen displayed on the display section of the portable terminal;

FIG. 21 is a diagram illustrating an example of an unsorted commodity screen displayed on the display section of the portable terminal; and

FIG. 22 is a flowchart exemplifying the procedures of the electronic receipt receiving processing and the purchased commodity management processing of the portable terminal.

### DETAILED DESCRIPTION

According to an embodiment, a terminal device includes a display, an communication interface, a memory and a controller. The communication interface receives extended receipt information that identifies a commodity subject to a transaction and a classification data for classifying the commodity. The memory stores the extended receipt information, a commodity image data representing the commodity, and at least one of a plurality of screen data each representing a different possible virtual management location of the commodity. The controller determines a specific virtual management location of the commodity from the different possible virtual management locations based on the classification data, and controls the display to display the commodity image included in a screen based on the screen data corresponding to the determined specific virtual management location of the commodity.

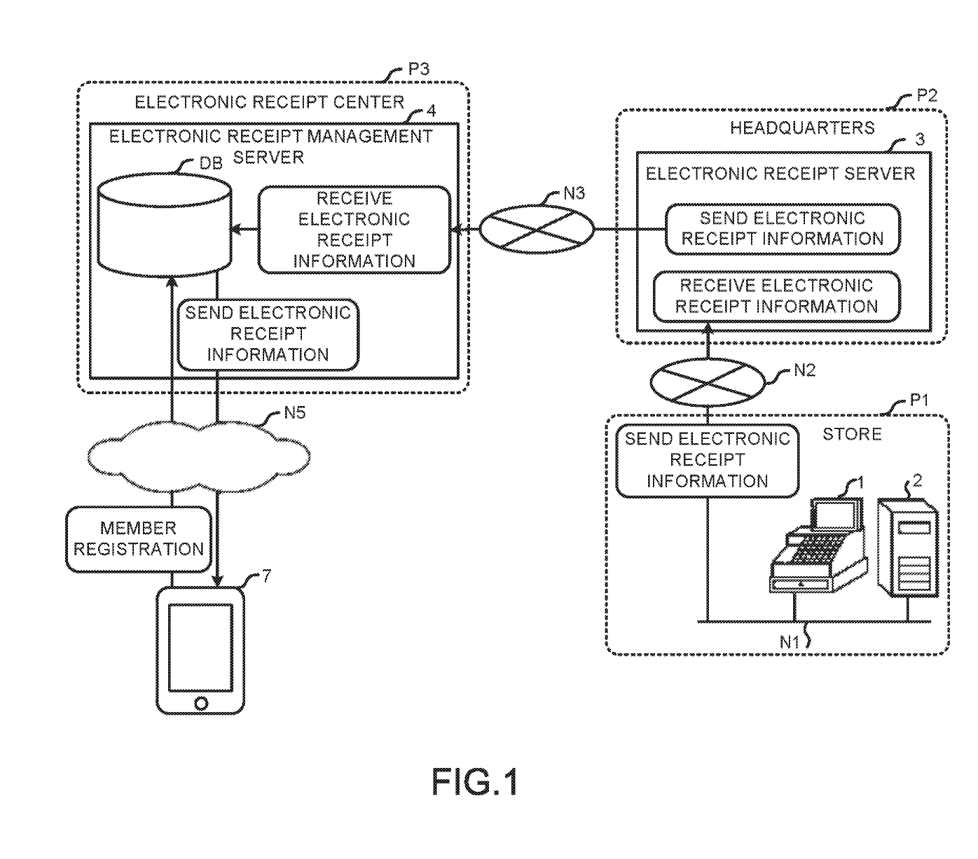

FIG. 1 is a diagram exemplifying the structure of an electronic receipt system of the embodiment. As shown in FIG. 1, the electronic receipt system consists of a POS (Point of Sales) terminal 1, a store server 2, an electronic receipt server 3, an electronic receipt management server 4 and a portable terminal 7.

The POS terminal 1 and the store server 2 are arranged inside a store P1. The POS terminal 1 and the store server 2 are communicably connected with each other via a network N1 in the store. The network N1 may be, for example, a Local Area Network (LAN). The POS terminal 1 and the store server 2 can be connected with a network N2 that connects the store P1 with headquarters P2 via a network mechanism (not shown) such as a router connected with the network N1 in the store. Herein, the network N2 is a dedicated line, for example, an internet or a Virtual Private Network (VPN).

The POS terminal 1 is a commodity sales data processing apparatus for executing a commodity sales data processing. The POS terminal 1 generates receipt information containing transaction contents of commodities to be settled and outputs a paper receipt on which the receipt information is printed by a under-mentioned printer 13. The receipt information comprises a commodity name, a price and the like of each commodity to be transacted and information relating to transaction contents.

The POS terminal 1 outputs electronic receipt information obtained by converting data format of the receipt information to the electronic receipt server 3 via the network N2. Not specifically limited to a sending method of the electronic receipt information, the electronic receipt information may be sent using a general protocol such as HTTP or HTTPS. Further, the number of the POS terminals 1 arranged in the store P1 may be plural.

The store server 2 collectively manages the commodity sales data processing carried out by each POS terminal 1. For example, the store server 2 stores commodity sales data generated by the commodity sales data processing carried out by the POS terminal 1 and a commodity data file used in the commodity sales data processing to manage them.

In the present embodiment, it is described that the POS terminal 1 outputs the electronic receipt information; however, the present invention is not limited to this. The receipt information generated by the POS terminal 1 may be converted into the data format with the store server 2 and a conversion device (not shown). The converted data may be output to the electronic receipt server 3 as the electronic receipt information.

The electronic receipt server 3 is arranged in the headquarters P2 of a company that runs stores or chain stores (hereinafter, referred to as stores) and functions as a receipt management server for company to manage electronic receipt information of each company that runs the store. The electronic receipt server 3 has, for example, a sales management function, a sales analysis function and an inventory management function for the company that runs the store.

Further, the electronic receipt server 3 receives the electronic receipt information sent from the POS terminal 1 via the network N2. The electronic receipt server 3 sends (transfers) the received electronic receipt information to the electronic receipt management server 4 via a network N3 that connects the headquarters P2 with the electronic receipt center P3.

Herein, the network N3 is a dedicated line, for example, an internet or a VPN. Further, no specific limitations are given to a sending method of the electronic receipt information. The electronic receipt information may be sent using a general protocol such as HTTP and HTTPS.

The electronic receipt management server 4 is arranged in the electronic receipt center P3. The electronic receipt center P3 is, for example, a third-party organization different from the company that manages the electronic receipt information through the electronic receipt server 3. The electronic receipt server 3 may also be managed by the third-party organization.

The electronic receipt management server 4 functions as a receipt management server for customer to collectively manage the electronic receipt information of various companies that run the stores. The electronic receipt management server 4 stores and manages member data such as a name, a member code (reception destination code) of each customer (member) who carries out a member registration through procedures described later. The electronic receipt management server 4 also stores and manages sending destination information (e.g., mail address) of the portable terminal 7 acting as a sending destination of the electronic receipt information in a member master file held in a database DB. In addition to the electronic receipt management server 4, a member management server for storing and managing the member data may be provided.

The electronic receipt management server 4 receives the electronic receipt information sent from the electronic receipt server 3 via the network N3 and stores and manages the received electronic receipt information in an electronic receipt management area 43a held in the database DB (described further below). More specifically, the electronic receipt information includes not only transaction contents of the commodity (commodity sales data) but also elements such as the member code and the like, and is managed in association with the member data of corresponding member.

Further, if the electronic receipt information is stored in the database DB, the electronic receipt management server 4 refers to the sending destination information associated with the member code contained in the electronic receipt information to specify the sending destination (the portable terminal 7). Then, the electronic receipt management server 4 sends the electronic receipt information stored in the database DB to the sending destination of the electronic receipt information via a network N5 described later.

If an inquiry of the electronic receipt information about the designation of a member code is received from the portable terminal 7 connected with the electronic receipt management server 4 via the under-mentioned network N5, the electronic receipt management server 4 extracts the electronic receipt information corresponding to the member code from the database DB and sends the extracted electronic receipt information to the portable terminal 7.

The portable terminal 7 corresponds to an information processing apparatus of the present embodiment. The portable terminal 7 used by a user (customer) of the present system is a terminal device, for example, a smart phone, a mobile phone, a PDA (Personal Digital Assistant), a laptop computer, a tablet computer and the like. The portable terminal 7 is installed with applications such as a Web browser for browsing various kinds of information provided by the network N5. Further, a terminal device such as a PC may be applicable instead of the portable terminal 7.

The portable terminal 7 accesses the electronic receipt management server 4 via the network N5 to carry out a member registration to the present system. Herein, the network N5 is an internet or various public networks.

The member registration of the customer to the present system is carried out by, for example, the following procedures. The customer sends a blank mail from the portable terminal 7 to the electronic receipt management server 4 via the network N5. The electronic receipt management server 4 sends a Uniform Resource Locator (URL) indicating a page for the member registration to the received mail address. The customer accesses the URL indicating a page for the member registration from the portable terminal 7 to display an input screen on which items (name, sending destination information and the like) required for the member registration are input. After the customer completes the input of necessary items, the electronic receipt management server 4 executes the member registration with respect to the member master file. Afterwards, the electronic receipt management server 4 distributes a member registration completion mail consisting of a member code (customer code) and a password to the portable terminal 7. In this way, the member registration is terminated.

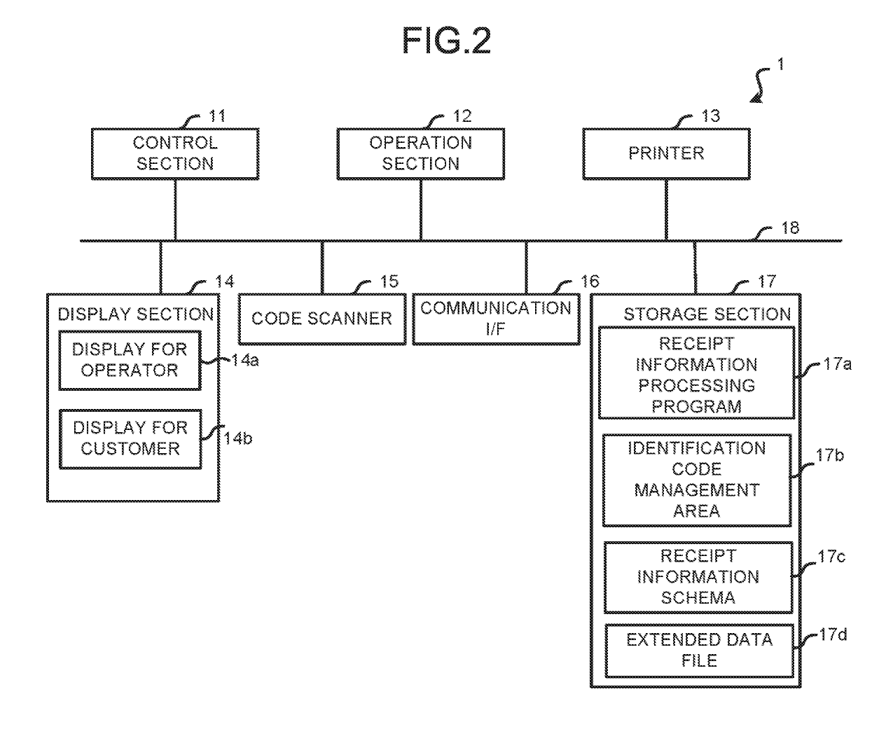

After the member registration described above, the portable terminal 7 takes the member code of the customer as the reception destination code and displays it on a display section 73 (refer to FIG. 7) as a code symbol such as a barcode and a two-dimensional code. The customer presents the code symbol displayed on the portable terminal 7 to a shop clerk at the time of a transaction settlement in the store P1. The shop clerk uses a code scanner 15 (refer to FIG. 2) connected with the POS terminal 1 to read the code symbol displayed on the portable terminal 7. In this way, it is possible that the member code of the customer is associated with the electronic receipt information generated after the settlement of the commodity sales data processing executed by the POS terminal 1.

Further, after the settlement transaction is carried out by the POS terminal 1, the portable terminal 7 receives the electronic receipt information of the transaction sent from the electronic receipt management server 4 via the network N5. The portable terminal 7 receives the electronic receipt information of the member from the electronic receipt management server 4 by sending an inquiry for the electronic receipt information and the member code corresponding to the member to the electronic receipt management server 4 via the network N5. The portable terminal 7 displays the received electronic receipt information on the display section 73.

In the electronic receipt system with such a structure, the electronic receipt information indicating the contents of the transaction (settlement) generated by the commodity sales data processing which is carried out by the POS terminal 1 of the store P1 is transferred to the electronic receipt management server 4 via the electronic receipt server 3 and is published on a Web. Thus, the portable terminal 7 installed with the Web browser, by designating an URL (Uniform Resource Locator), downloads the electronic receipt information published on the Web in the portable terminal 7 and then can browse the downloaded electronic receipt information through the Web browser. An application for browsing the electronic receipt information is installed in the portable terminal 7 to be used to browse the electronic receipt information.

Next, the electronic receipt system of the present embodiment is described.

First, the POS terminal 1 serving as the commodity sales data processing apparatus is described. FIG. 2 is a block diagram exemplifying the structure of the POS terminal 1. As shown in FIG. 2, the POS terminal 1 comprises a control section 11 for collectively controlling various operations and each section of the POS terminal 1. The control section 11 is a computer with a Central Processing Unit (CPU), a Read Only Memory ROM) for storing various programs and data, a Random Access Memory (RAM) for temporarily storing various programs and storing various data in a rewritable manner, and a Real Time Clock (RTC) section for clocking current date and time.

The control section 11 is connected with an operation section 12, a printer 13, a display section 14 and the code scanner 15 via a bus line 18.

The operation section 12 has various operation keys used by an operator to carry out input operations. The operations keys include, for example, numerical keys for inputting numerical values, cursor keys and selection determination keys for selecting specific items, a subtotal key for instructing a total output of the commodities to which a sales registration in the transaction is carried out, and a closing key for closing one transaction to declare the settlement of prices.

The printer 13 is a printer device for printing a receipt or a report. The printer 13 which is equipped with a cutting mechanism (not shown) for cutting out a paper such as a rolled paper to be printed cuts out a paper according to a cut command described later.

The display section 14, which is, for example, a liquid crystal display, displays various kinds of information such as the name and the price of the commodity to which the sales registration is carried out and total amount and change amount of one transaction whose settlement is declared. The display section 14 is provided with a display for operator 14a for displaying various kinds of information towards a cashier and a display for customer 14b for displaying various kinds of information towards the customer. Further, the display section 14 may be a touch panel, and in this case, the touch panel functions as the operation section 12.

The code scanner 15 is a scanner device for optically reading the code symbol such as the barcode and the two-dimensional code. The code scanner 15, for example, reads the code symbol attached to a commodity and the code symbol displayed on the portable terminal 7 and outputs information held in the code symbol to the control section 11. It is assumed that the commodity code for specifying the commodity is stored in the code symbol attached to the commodity. It is assumed that the member code (customer code) for specifying the customer who carries the portable terminal 7 is stored in the code symbol displayed on the portable terminal 7.

Further, the control section 11 is connected to a communication interface (I/F) 16 via the bus line 18. The network N1 in the store and the network N2 can be connected to each other via the communication I/F 16.

The control section 11 is connected to a storage section 17 via the bus line 18. The storage section 17 is an auxiliary storage device such as, for example, an HDD (Hard Disk Drive) and an SSD (Solid State Drive). The storage section 17 stores programs for executing various POS jobs performing the commodity sales data processing. Further, the storage section 17 stores various data files relating to the commodity sales data processing such as a commodity data file for storing commodity data such as a commodity name, a commodity code, a unit price of each commodity, and a point file. The storage section 17 stores a receipt information processing program 17a for carrying out the commodity sales data processing and a processing relating to receipt information.

The commodity data file stores special sale information and the maximum purchase quantity for each commodity. The point file stores effective date of points associated with the member code.

The storage section 17 stores POS numbers for separately identifying each POS terminal 1, a company code (identification code of a company that runs the store), business category/business style code and a store code indicating the store P1 in which the POS terminal 1 is arranged in an identification code management area 17b. Herein, the business category/business style code is a code (classification code) for distinguishing the business category and business style of the store including, for example, a convenience store, a supermarket, a department store, a pharmacy, a restaurant, an eating house and the like. Such a business category and a business style may be selectively changed according to the preference of a user. The company code (identification code of the company that runs the store) and the business category/business style code are registered in the electronic receipt server 3.

The storage section 17 stores a receipt information schema 17c depicting a conversion rule which is used when the receipt information in an unstructured form is converted into the electronic receipt information in a structured form.

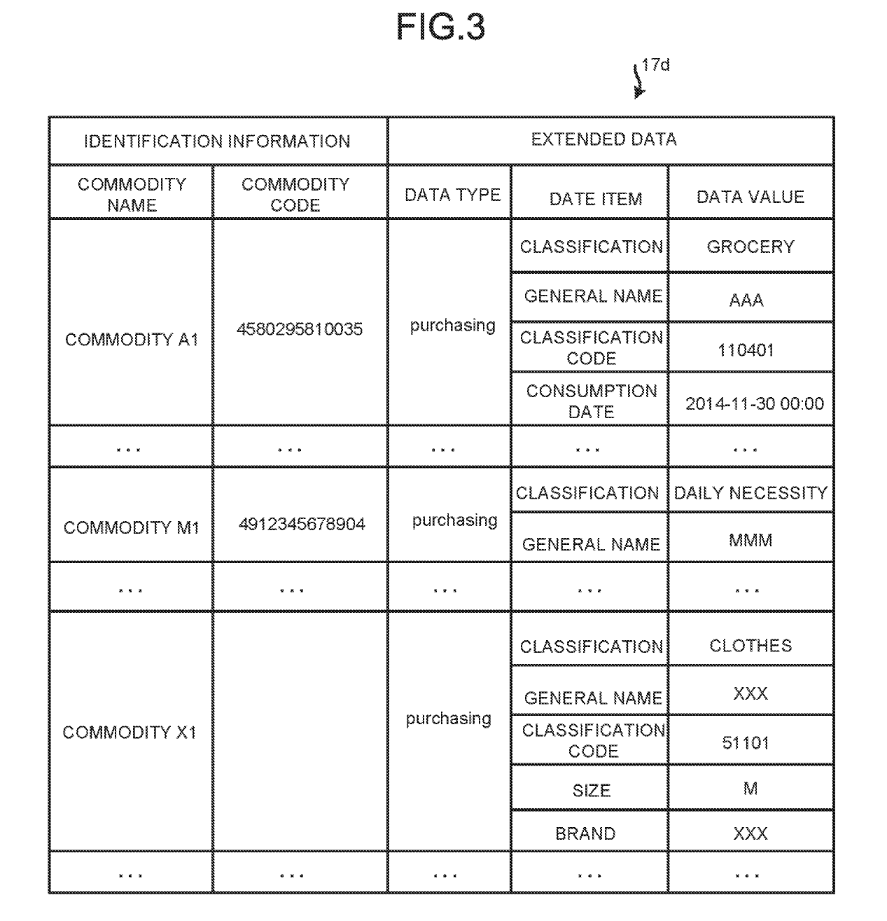

Further, the storage section 17 stores an extended data file 17d for storing extended data relating to each commodity (described further below). FIG. 3 is a diagram exemplifying the data structure of the extended data file 17d.

As shown in FIG. 3, the extended data file 17d is associated with the identification information capable of identifying each commodity and stores extended data (additional information) relating to the commodity. The items of the identification information contain, for example, the commodity name and/or the commodity code.

The extended data is a set of data including, for example, a data type, a data item and a data value. The data type corresponds to a classification name when the extended data is classified by a predetermined standard. The data type functions as a use classification for designating a range of usable extended data in the portable terminal 7 which receives electronic receipt information (extended data) described later. Further, no specific limitations are given to names of the data types and classification methods which can be set as desired. For example, the extended data may be classified according to the features and uses of the data item (data value). The extended data may also be classified on the basis of an application that uses the data item (data value). In FIG. 3, it is exemplified that “purchasing” is set as the data type.

In the data item, item names of various kinds of information relating to a commodity are stored. In FIG. 3, for example, it is exemplified that a classification (classification name), a general name, a classification code, and a consumption date (or expiration date) of commodity corresponding to data type “purchasing” of a commodity A1 are set. The classification name, the general name and the classification code corresponds to the classified information of the present embodiment. The classification code, for example, may use a general code system based on a standard such as JICFS. No specific limitations are given to a value for setting the data item which can be set optionally according to the type and feature of the commodity.

In the data value, values of data corresponding to the data item are stored. For example, in a case in which the data item is “classification”, the extended values “grocery”, “daily necessity” and “clothes” are stored in the data value. Further, the data structure of the extended data file 17d is not limited to the example of FIG. 3.

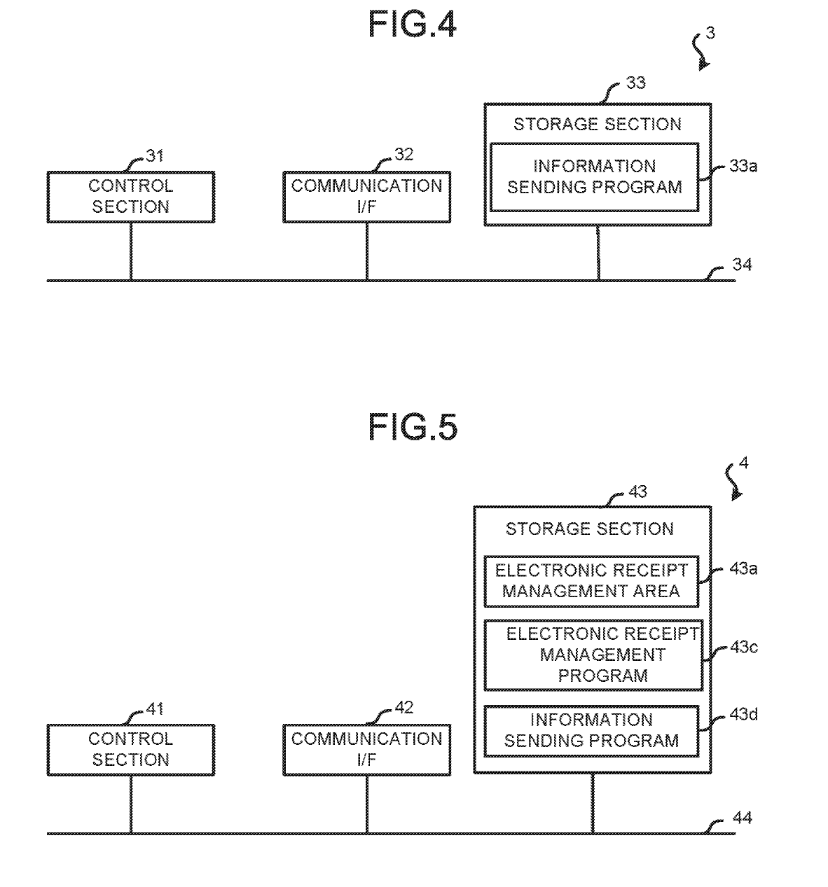

Next, the structure of the electronic receipt server 3 functioning as the receipt management server for company is described with the use of a block diagram of FIG. 4. FIG. 4 is a block diagram exemplifying the structure of the electronic receipt server 3.

As shown in FIG. 4, the electronic receipt server 3 is equipped with a control section 31 for collectively controlling various operations and each section of the electronic receipt server 3. The control section 31 is a computer that includes a CPU, a ROM for storing various programs and data, a RAM for temporarily storing various programs and storing various data in a rewritable manner and an RTC section for clocking current date and time.

The control section 31 can be connected with the network N2 and the network N3 via a communication I/F 32 connected with a bus line 34. Further, the control section 31 is connected with a storage section 33 via the bus line 34. The storage section 33 stores an information sending program 33a for sending (transferring) the electronic receipt information sent from the POS terminal 1 to the electronic receipt management server 4.

Next, the structure of the electronic receipt management server 4 functioning as the receipt management server for customer is described with the use of a block diagram of FIG. 5. FIG. 5 is a block diagram exemplifying the structure of the electronic receipt management server 4.

As shown in FIG. 5, the electronic receipt management server 4 is equipped with a control section 41 for collectively controlling various operations and each section of the electronic receipt management server 4. The control section 41 is a computer that includes a CPU, a ROM for storing various programs and data, a RAM for temporarily storing various programs and storing various data in a rewritable manner and an RTC section for clocking current date and time.

The control section 41 can be connected with the network N3 and the network N5 via a communication I/F 42 connected with a bus line 44. Further, the control section 41 is connected with a storage section 43 via the bus line 44.

In addition to a member master file management area (not shown) for storing and managing the member master file, an electronic receipt management area 43a for collectively storing the electronic receipt information of various companies that run the stores is included in the storage section 43. More specifically, the electronic receipt management area 43a manages the electronic receipt information of various companies that run the stores for each member.

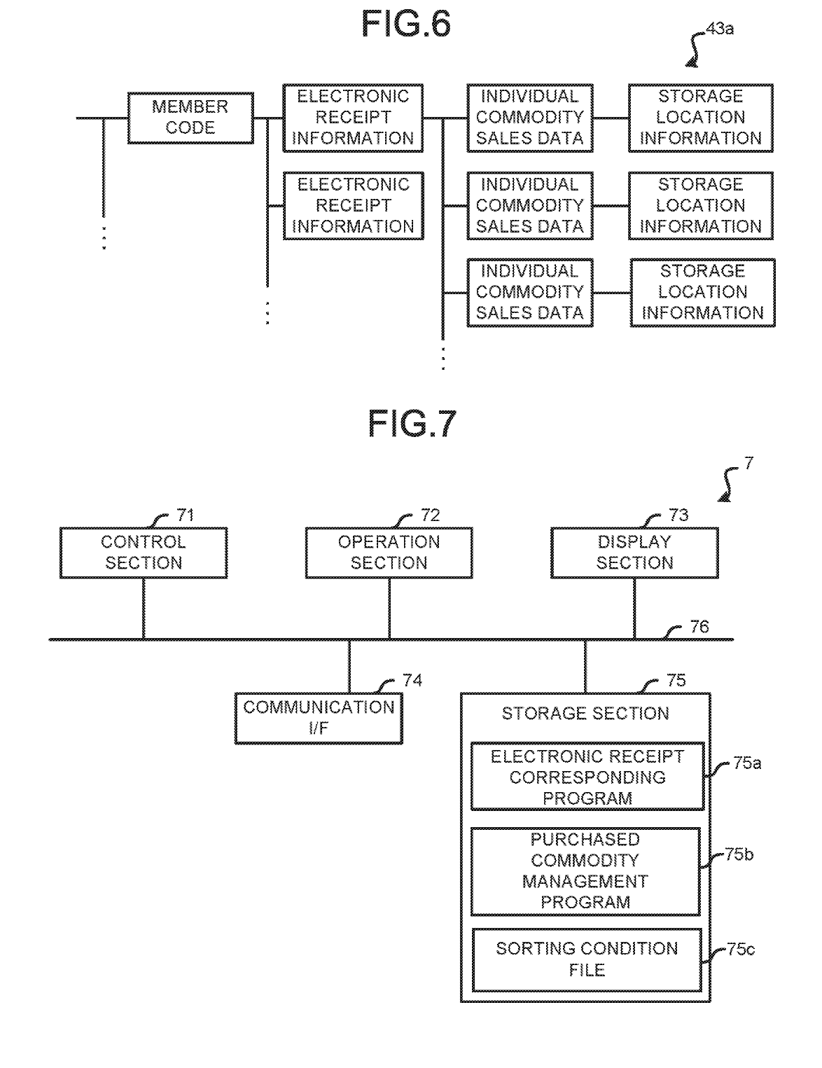

FIG. 6 is a diagram schematically illustrating the data structure of the electronic receipt management area 43a. As shown in FIG. 6, the electronic receipt management area 43a stores each member code and electronic receipt information relating to the member code in an associated manner. Further, the electronic receipt management area 43a stores storage location information indicating the storage location of the commodity in association with each commodity (individual commodity sales data D20) contained in the electronic receipt information.

In addition to a member management program (not shown) for managing the member master file in the member master file management area, the storage section 43 stores an electronic receipt management program 43c for managing the electronic receipt information of each company in the electronic receipt management area 43a. Further, the storage section 43 stores an information sending program 43d for sending the electronic receipt information to the portable terminal 7. The member master file management area and the electronic receipt management area 43a correspond to the database DB shown in FIG. 1.

Next, the structure of the portable terminal 7 is described with the use of a block diagram of FIG. 7. FIG. 7 is a block diagram exemplifying the structure of the portable terminal 7.

As shown in FIG. 7, the portable terminal 7 is equipped with a control section 71 for collectively controlling various operations and each section of the portable terminal 7. The control section 71 is a computer that includes a CPU, a ROM for storing various programs and data, a RAM for temporarily storing various programs and storing various data in a rewritable manner and an RTC section for clocking current date and time.

The control section 71 is connected with an operation section 72 and the display section 73 via a bus line 76. The operation section 72 includes various operation keys used by a user (customer) to carry out input operations and a pointing device. The display section 73, which is, for example, a liquid crystal display, displays various kinds of information such as electronic receipt information described later. Further, the display section 73 may be a touch panel, and in this case, the touch panel functions as the operation section 72.

The control section 71 connected with a communication I/F 74 via the bus line 76 can be also connected with the network N5 via the communication I/F 74. The control section 71 may also be connected with the network N1 in the store via the communication I/F 74.

The control section 71 is also connected with a storage section 75 via the bus line 76. The storage section 75 stores a Web browser for browsing various kinds of information (contents) published on the Web. The storage section 75 also stores an electronic receipt corresponding program 75a for receiving electronic receipt information from the electronic receipt management server 4 and a purchased commodity management program 75b for browsing the received electronic receipt information. Further, the storage section 75 stores a sorting condition file 75c for setting sorting conditions at the time the commodities are sorted in the storage location.

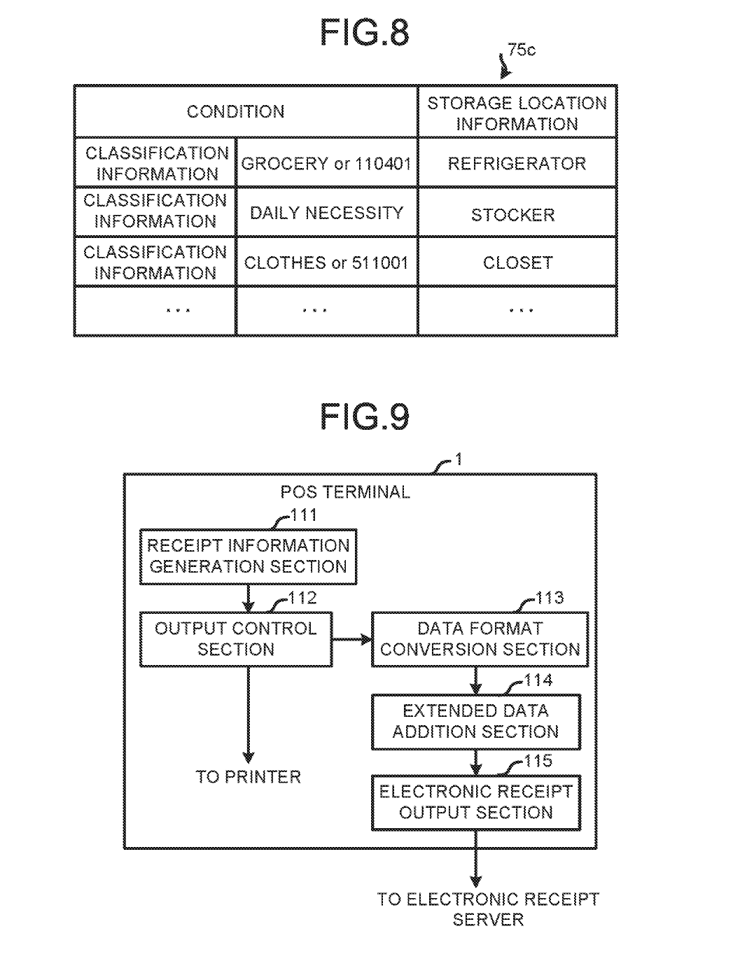

FIG. 8 is a diagram exemplifying schematically the data structure of the sorting condition file 75c. As shown in FIG. 8, the sorting condition file 75c stores a condition (sorting condition) of sorting commodities and the storage location information indicating a sorting destination (storage destination) corresponding to the condition in an associated manner. Herein, various elements contained in the electronic receipt information can be set as the sorting condition. In FIG. 8, “classification name” and “classification code” serving as classified information contained in extended data D30 are exemplified as the sorting condition. In FIG. 8, for example, in a case in which the classification name is “grocery” or the classification code is “110401”, it is defined that the storage location of the commodity is sorted into “refrigerator”. It is preferred to set the storage destination corresponding to the sorting condition in the storage location information.

The data structure of the sorting condition file 75c is not limited to the example of FIG. 8 and can be optionally set. For example, other elements such as “general name” may be set in the sorting condition as other classified information contained in the extended data D30. Further, a plurality of sorting conditions is applicable to the same commodity. Thus, a structure like the derivation of one sorting destination may be introduced by setting priority in each sorting condition in a case in which different sorting destinations are derived.

Next, the operation of each of sections that constitute the system of the present embodiment is described.

First, the electronic receipt processing executed by the operation of the control section 11 of the POS terminal 1 according to the receipt information processing program 17a is described with reference to FIGS. 9-12.

FIG. 9 is a block diagram exemplifying functional sections relating to the electronic receipt processing of the POS terminal 1. As shown in FIG. 9, the receipt information processing program 17a executed by the POS terminal 1 has a module structure consisting of a receipt information generation section 111, an output control section 112, a data format conversion section 113, an extended data addition section 114 and an electronic receipt output section 115. By reading out the receipt information processing program 17a from the storage section 17 and executing it with the CPU of the control section 11, each functional section is loaded on the RAM to be implemented in actual hardware.

The receipt information generation section 111 is a functional section for mainly carrying out the commodity sales data processing and generation of print data of receipt (receipt information). The receipt information generation section 111 reads out the commodity data corresponding to a commodity code from the commodity data file if the commodity code for specifying a commodity is acquired via the code scanner 15, and executes the commodity sales data processing for calculating settlement amount based on a unit price contained in the commodity data. Then, the receipt information generation section 111 generates commodity sales data processed in the commodity sales data processing. That is, the receipt information generation section 111 generates receipt information containing transaction contents of the commodity.

Further, the receipt information generation section 111 generates receipt information containing a member code of a customer if the member code for specifying the customer is acquired via the code scanner 15 during any time of one transaction. The receipt information generation section 111, in a case of acquiring a member code, may generate receipt information containing information indicating the acquisition of the member code (acquisition information).

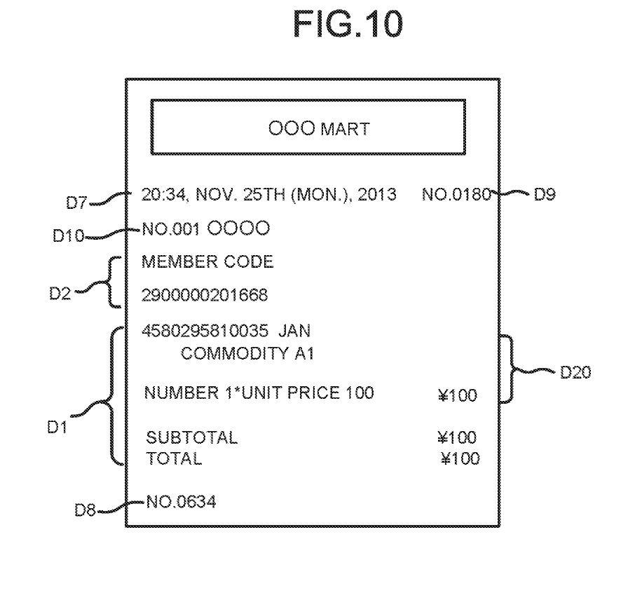

FIG. 10 is a diagram illustrating schematically an example of receipt information. Herein, the receipt information is text data in an unstructured form and used for the printing of the printer 13. As shown in FIG. 10, the receipt information includes the above-mentioned commodity sales data D1 and an element D2 relating to a member code (acquisition information “member code”, member code “2900000201668”). The commodity sales data D1 includes a commodity name, a commodity code, an amount of a commodity to be settled, a total amount of each commodity, a deposit amount paid by the customer, and a change amount. The commodity name, the commodity code, the amount and the like of the commodity to be settled are arranged for each commodity in the individual commodity sales data D20.

The receipt information includes elements such as transaction date and time D7, transaction number (receipt number) D8, register number D9 and name of person in charge D10. The elements included in the receipt information, which are not limited to the example of FIG. 10, also includes other elements such as the company code (company name) indicating the company that runs the store, the store code (store name) and telephone number, address and business category/business style code of the store.

If the press on the closing key is received, the receipt information generation section 111 determines that the commodity sales data processing corresponding to one transaction is completed and outputs (issues) the generated receipt information and the cut command to the output control section 112. Herein, the cut command is one of printer control commands used in general for instructing the cutting of the paper on which the receipt information is printed. The receipt information may be generated collectively along with the press of the closing key or every time the commodity code and the customer code are acquired.

The output control section 112 determines an output destination of the receipt information every time receipt information corresponding to one transaction is generated by the receipt information generation section 111. More specifically, the output control section 112 determines that the receipt information corresponding to one transaction is generated by the receipt information generation section 111 if the cut command is issued. Then, the output control section 112 determines whether the member code is contained in the generated receipt information and outputs the receipt information to the output destination determined according to the determined result. In a case in which the receipt information contains the acquisition information, the output control section 112 may determine the output destination according to whether the acquisition information or a group of the acquisition information and the member code is contained in the generated receipt information.

Specifically, if it is determined that the member code is not contained in the receipt information, the output control section 112 outputs the receipt information and the cut command to the printer 13. In this way, after the receipt information is printed on the paper, the printer 13 cuts out the printed paper according to the cut command to print out paper receipt corresponding to one transaction. At the time of printing output, all the elements composed of the receipt information may be printed or the paper receipt may be printed without the member code and the acquisition information but adding other information such as an advertisement.

The output control section 112, if it is determined that the receipt information contains the member code, outputs the receipt information to the data format conversion section 113.

The data format conversion section 113 converts the receipt information input from the output control section 112 into a specific data format according to the conversion rule depicted in the receipt information schema 17c. Then, the output control section 112 outputs the receipt information converted into the data format (i.e., electronic receipt information) to the extended data addition section 114.

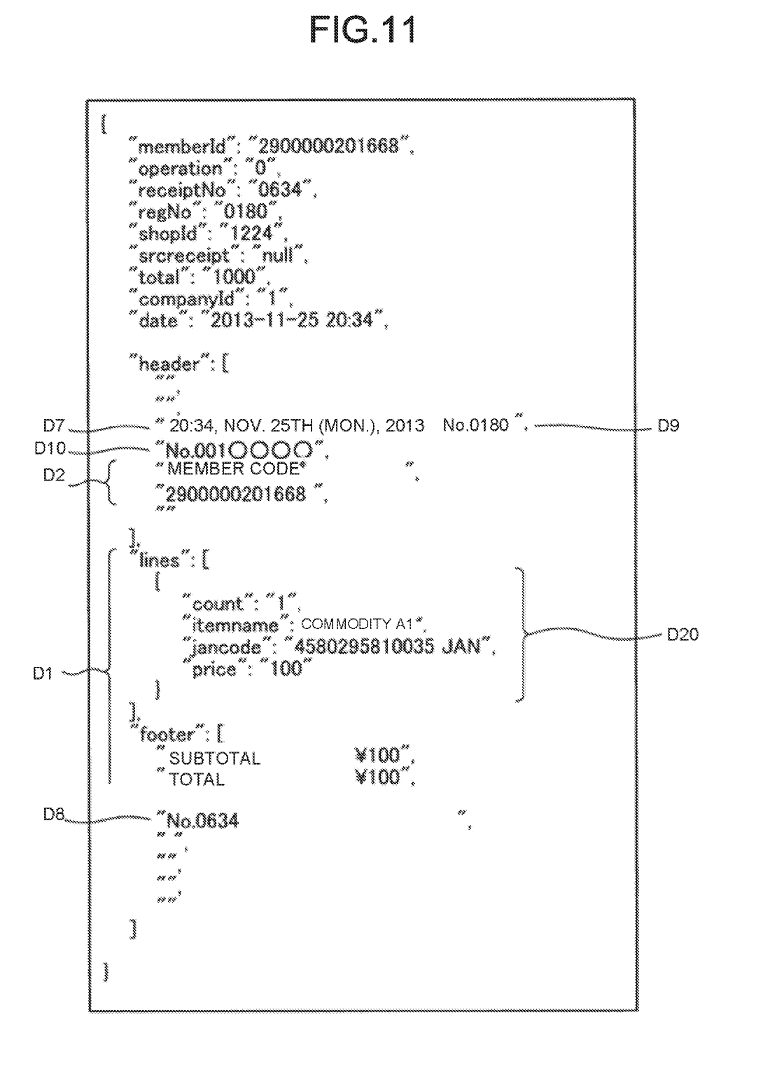

FIG. 11 is a diagram illustrating schematically an example of the electronic receipt information. As shown in FIG. 11, the electronic receipt information includes data in a structured format such as XML, CSV, JSON (JavaScript® Object Notation) or the like. In FIG. 11, it is exemplified that each element (D1-D2, D7-D10 and D20) of the receipt information shown in FIG. 10 is converted into a JSON format. For example, the individual commodity sales data D20 shown in FIG. 10 is converted into structured data shown in FIG. 11 by making each element structured with the use of parenthesis and double quotation.

The conversion from the receipt information to the electronic receipt information is carried out on the basis of the conversion rule depicted in the receipt information schema 17c. Specifically, specific elements constituting the receipt information and attribute information (tag, etc.) indicating attributes of the elements are defined in the receipt information schema 17c. The output control section 112 generates the electronic receipt information with a structured form shown in FIG. 11 by structuring each element of the receipt information with the corresponding attribute information.

Return to FIG. 9, the extended data addition section 114 adds the extended data to the electronic receipt information generated (converted) by the data format conversion section 113. More specifically, the extended data addition section 114 analyzes the structure and content of the electronic receipt information and extracts the identification information such as the commodity name, the commodity code and the like of each commodity contained in the commodity sales data D1. Subsequently, the extended data addition section 114 takes the extracted identification information of each commodity as retrieval keys and retrieves extended data corresponding to the retrieval keys from the extended data file 17d. Then, the extended data addition section 114 adds (appends) the acquired extended data of each commodity in association with the individual commodity sales data D20 of the corresponding commodity. The extended receipt information of the present embodiment is the electronic receipt information added to the extended data.

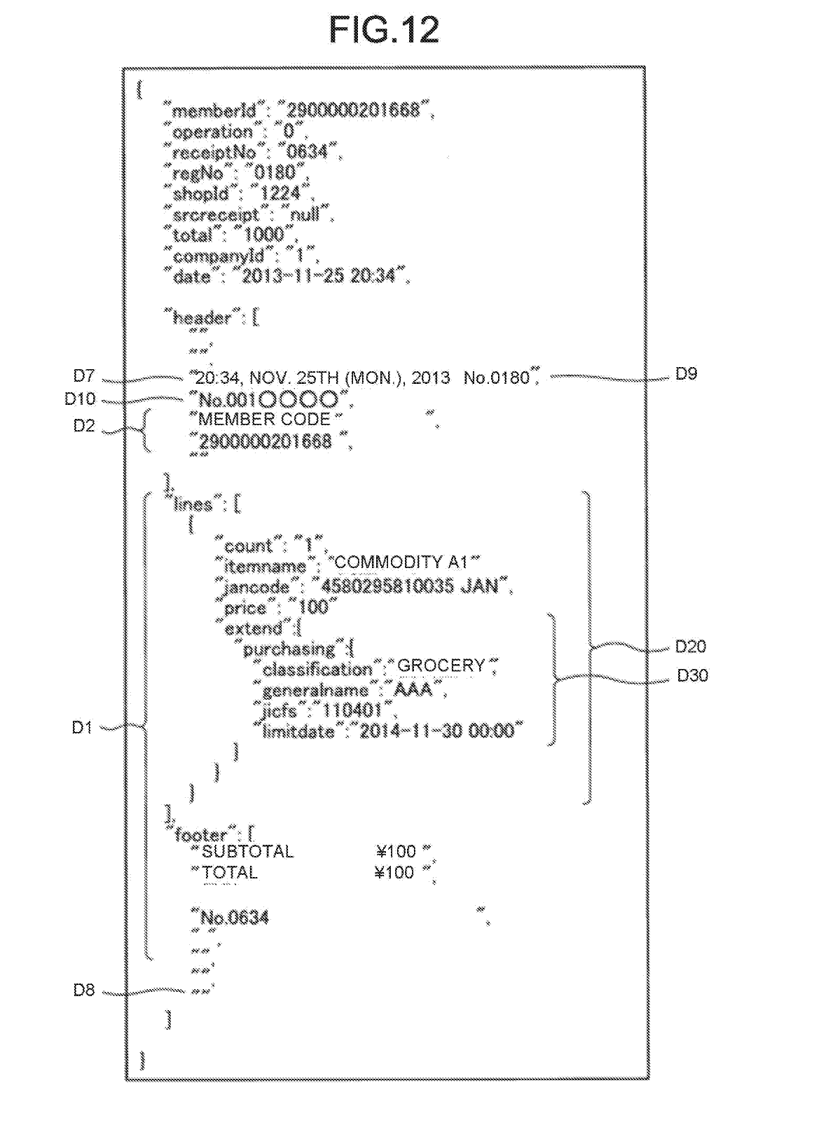

FIG. 12 is a diagram illustrating schematically an example of the electronic receipt information added to the extended data. The electronic receipt information added to the extended data shown in FIG. 12 corresponds to the electronic receipt information shown in FIG. 11. For example, if the extended data of “commodity A1” is acquired from the extended data file 17d (refer to FIG. 3), the extended data addition section 114 adds the acquired extended data of “commodity A1” in the individual commodity sales data D20 of the commodity A1 as the extended data D30. Herein, the extended data D30 is defined by a tag “extend” and depicted in a structured form identical to other elements.

A tag “purchasing” (hereinafter, referred to as a “data type tag”) in the extended data D30 corresponds to the data type described in FIG. 3. Further, a set of the data items such as the classification, the general name, the classification code and the consumption date and the data value is depicted in the data type tag in a structured form. In FIG. 12, the extended data D30 is defined with the tag “extend”, but the extended data D30 is not limited to this form. Further, it is assumed that the method of noting the extended data D30 is not limited to the example of FIG. 12.

Return to FIG. 9, the electronic receipt output section 115 sends the electronic receipt information, with the extended data added, by the extended data addition section 114 to the electronic receipt server 3 that is managed by the company unit corresponding to the company code.

In this way, through the POS terminal 1, the receipt information for printing on the paper (sheet) is converted into a structured form and the extended data relating to each commodity in the transaction is added in the converted electronic receipt information and transmitted to an external device. In this way, additional contents other than the contents on the paper receipt (receipt information to be printed on the paper) are managed, and thus usefulness of the electronic receipt is improved. Further, with the electronic receipt information in a structured form, the elements contained in the electronic receipt information can be used efficiently, and thus various advantages of data management can be obtained.

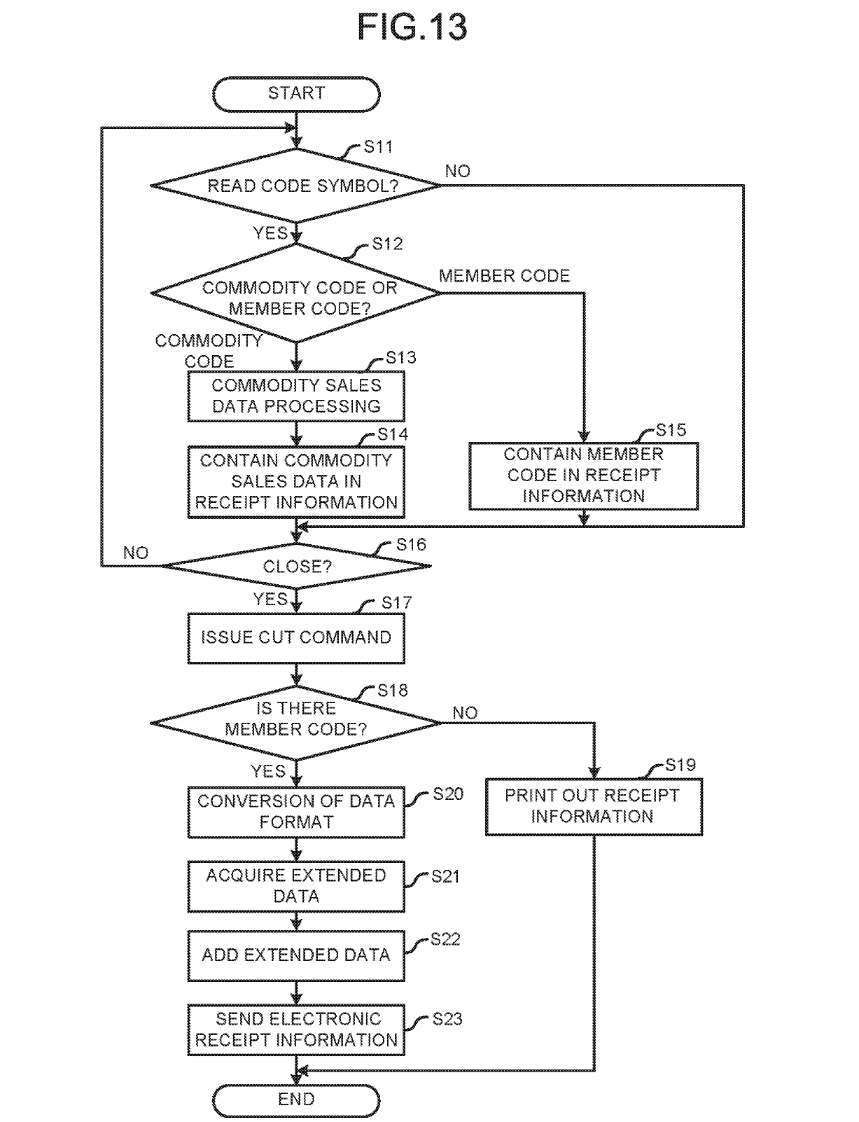

FIG. 13 is a flowchart exemplifying the procedure of the electronic receipt processing of the POS terminal 1. First, the receipt information generation section 111 of the POS terminal 1 determines whether the commodity code attached to the commodity or the member code displayed on the portable terminal 7 is read by the code scanner 15 (Act S11). If neither code symbol (the commodity code or the member code) is read (No in Act S11), the receipt information generation section 111 proceeds to Act S16.

On the other hand, if it is determined that the code symbol is read (Yes in Act S11), the receipt information generation section 111 determines wither the code symbol is the commodity code or the member code (Act S12).

In Act S12, in a case of acquiring the commodity code (commodity code in Act S12), the receipt information generation section 111 executes the commodity sales data processing for calculating the settlement amount based on the unit price contained in the commodity data for the commodity specified by the commodity code if the commodity data is read from the commodity data file (Act S13). Subsequently, the receipt information generation section 111 generates the receipt information containing the commodity sales data processed at the time of the commodity sales data processing (Act S14).

Further, in Act S12, in a case of acquiring the member code (member code in Act S12), the receipt information generation section 111 generates the receipt information containing the member code (Act S15). In Act S15, the receipt information containing the acquisition information illustrating the acquisition of the member code may be generated.

Herein, in order to input the member code to the POS terminal 1, for example, the customer serving as the member displays the code symbol containing the member code and the like on the display section 73 of the portable terminal 7, and the shop clerk or the customer serving as the member reads the member code through the code scanner 15 of the POS terminal 1. The receipt information generation section 111 may perform a processing to uniquely identify the member code input during one transaction.

Next, in Act S16, the receipt information generation section 111 determines whether the start of a closing processing is instructed through the press of the closing key (Act S16). If the start of the closing processing is not instructed (No in Act S16), the receipt information generation section 111 returns to Act S11. If the start of the closing processing is instructed (Yes in Act S16), the receipt information generation section 111 issues (outputs) the cut command to the output control section 112 (Act S17).

The output control section 112, if the cut command is received from the receipt information generation section 111, determines that the receipt information corresponding to one transaction is generated and determines whether the member code is included in the receipt information (Act S18). If the receipt information includes the acquisition information, in Act S18, the output control section 112 may determine whether the acquisition information or the group of the acquisition information and the member code is contained.

If no member code is contained in the receipt information (No in Act S18), the output control section 112 outputs the receipt information corresponding to one transaction and the cut command to the printer 13 to print out the receipt information (Act S19), and then the present processing is terminated. In this way, after the receipt information is printed on the paper, the printer 13 prints out the paper receipt corresponding to one transaction and cuts the printed paper according to the cut command.

On the other hand, if the member code is contained in the receipt information (Yes in Act S18), the output control section 112 outputs the receipt information to the data format conversion section 113. The data format conversion section 113 generates the electronic receipt information by converting data format of the receipt information from an unstructured form into a structured form (Act S20).

Sequentially, if the identification information of each commodity is extracted from the electronic receipt information generated in Act S20, the extended data addition section 114 acquires the extended data corresponding to the identification information from the extended data file 17d (Act S21). Then, the extended data addition section 114 adds the acquired extended data to the electronic receipt information (Act S22).

Then, the electronic receipt output section 115 sends the electronic receipt information with the extended data added in Act S22 to the electronic receipt server 3 via the communication I/F 16 (Act S23) to terminate the present processing. The electronic receipt information sent to the electronic receipt server 3 is transferred to the electronic receipt management server 4 from the electronic receipt server 3.

When the member code is contained in the receipt information in the foregoing processing, the receipt information may be output to the electronic receipt server 3; however, the present invention is not limited to this. For example, the receipt information may be output to both the printer 13 and the electronic receipt server 3.

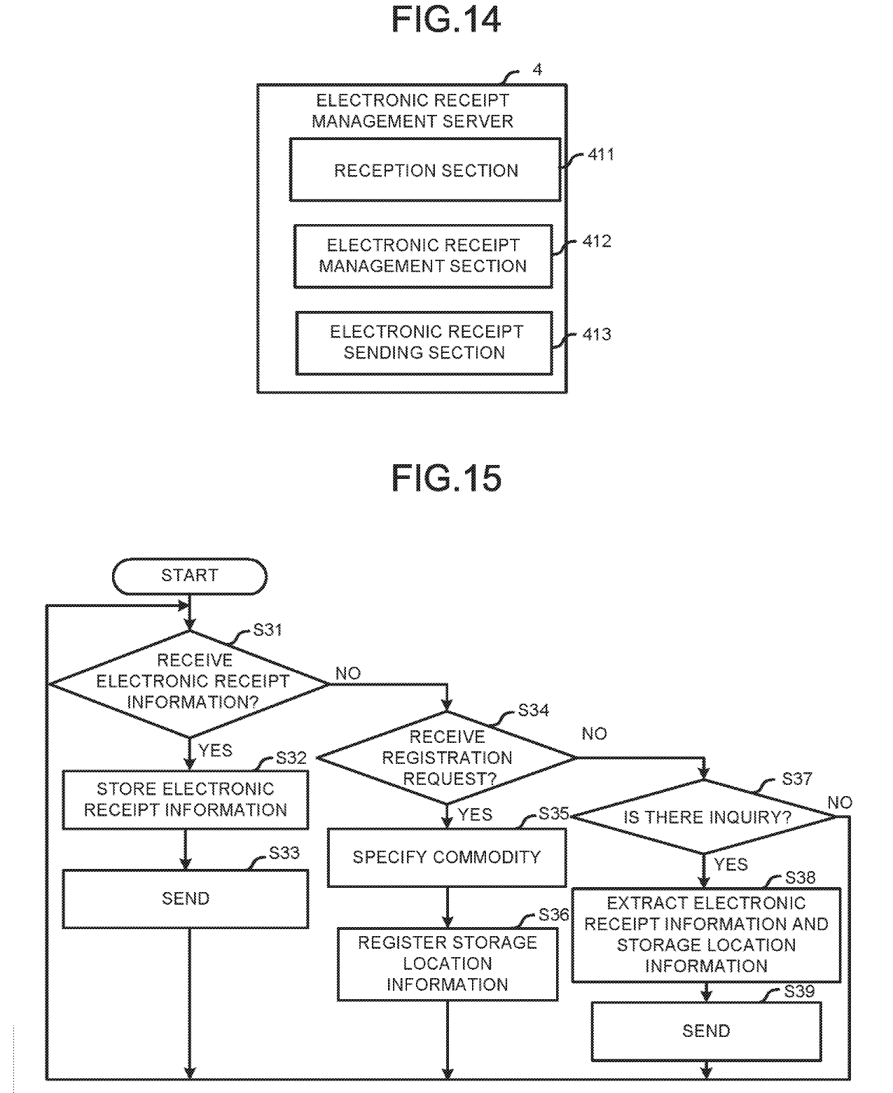

Next, flows of the electronic receipt management processing (executed according to the electronic receipt management program 43c) and the information sending processing (executed according to the information sending program 43d) by the control section 41 of the electronic receipt management server 4 are described with reference to FIGS. 14 and 15.

FIG. 14 is a block diagram exemplifying functional sections relating to the electronic receipt management processing and the information sending processing of the electronic receipt management server 4. As shown in FIG. 14, the electronic receipt management program 43c and the information sending program 43d executed by the electronic receipt management server 4 have a module structure consisting of a reception section 411, an electronic receipt management section 412 and an electronic receipt sending section 413. By reading out the electronic receipt management program 43c and the information sending program 43d from the storage section 43 and executing them with the CPU of the control section 41, each functional section is loaded on the RAM. In this manner, the reception section 411, the electronic receipt management section 412 and the electronic receipt sending section 413 are implemented in actual hardware.

The reception section 411 receives the electronically processed electronic receipt information of the company unit which contains the company code indicating the company that runs the store instead of the printed and issued receipt at the time of the commodity sales data processing from the electronic receipt server 3. The reception section 411 further receives a registration request of the storage location information described later from the portable terminal 7.

The electronic receipt management section 412 stores the electronic receipt information of the company unit received by the reception section 411 in the electronic receipt management area 43a of the storage section 43.

Further, if the registration request of the storage location information is received from the portable terminal 7, the electronic receipt management section 412 stores the storage location information in the electronic receipt management area 43a in association with the corresponding commodity (individual commodity sales data D20). It is assumed that the instruction information instructing the commodity serving as object together with the storage location information indicating the storage location is contained in the registration request sent from the portable terminal 7. The related instruction information includes, for example, a transaction number D8 for designating the electronic receipt information, a commodity code for designating a commodity and the like.

The electronic receipt sending section 413 acquires electronic receipt information associated with a member code of a specific customer and storage location information from the electronic receipt management area 43a and sends the acquired information to the portable terminal 7 associated with the member code. Further, the electronic receipt sending section 413 sends the electronic receipt information and the storage location information so that the storage location information and each commodity (individual commodity sales data D20) contained in the electronic receipt information are maintained in correspondence.

FIG. 15 is a flowchart exemplifying the procedures of the electronic receipt management processing and the information sending processing of the electronic receipt management server 4. First, the reception section 411 determines whether the electronic receipt information sent from the electronic receipt server 3 of each company is received via the communication I/F 42 (Act S31).

If the electronic receipt information is received (Yes in Act S31), the electronic receipt management section 412 stores the received electronic receipt information in the electronic receipt management area 43a of the storage section 43 (Act S32). At point in time of Act S32, the storage location information associated with each commodity of the electronic receipt information is null.

Sequentially, the electronic receipt sending section 413 sends the electronic receipt information stored in Act S32 together with the storage location information (null) to the sending destination (portable terminal 7) managed in association with the member code of the electronic receipt information (Act S33) and then returns to Act S31.

If the registration request of the storage location information is received from the portable terminal 7 (No in Act S31→Yes in Act S34), the electronic receipt management section 412 specifies a commodity to be registered from the electronic receipt management area 43a according to the instruction information contained in the registration request (Act S35). Then, the electronic receipt management section 412 associates the storage location information with the commodity specified in Act S35 to register it (Act S36) and then returns to Act S31.

If there is an inquiry of the electronic receipt information from the portable terminal 7 (No in Act S31→No in Act S34→Yes in Act S37), the electronic receipt sending section 413 extracts the electronic receipt information and the storage location information stored in the electronic receipt management area 43a based on the inquiry of the electronic receipt information (Act S38). Then, the electronic receipt sending section 413 sends the extracted electronic receipt information and storage location information to the portable terminal 7 from which the inquiry was sent (Act S39) and the Act returns to S31. The electronic receipt management server 4 returns to Act S31 to be in standby state if the electronic receipt information is not received, the registration request is not received, and the inquiry of the electronic receipt information is not received (No in Act S31→No in Act S34→No in Act S37).

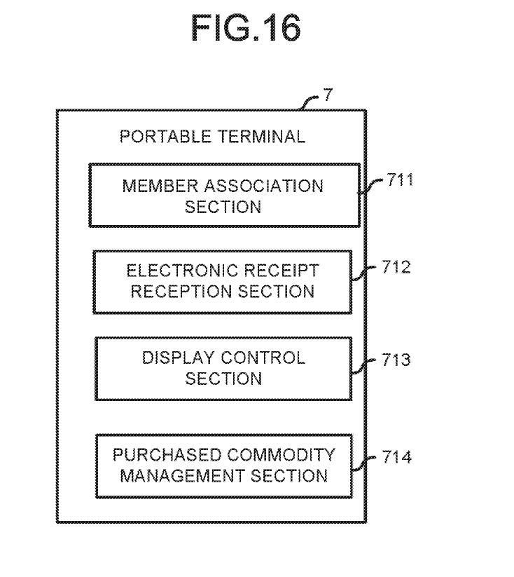

Next, flows of the electronic receipt receiving processing executed according to the electronic receipt corresponding program 75a and the purchased commodity management processing executed according to the purchased commodity management program 75b by the operation of the control section 71 of the portable terminal 7 are described with reference to FIGS. 16-22.

FIG. 16 is a block diagram exemplifying functional sections relating to the electronic receipt receiving processing and the purchased commodity management processing of the portable terminal 7. As shown in FIG. 16, the electronic receipt corresponding program 75a and the purchased commodity management program 75b executed by the portable terminal 7 have a module structure containing a member association section 711, an electronic receipt reception section 712, a display control section 713 and a purchased commodity management section 714. By reading out the electronic receipt corresponding program 75a and the purchased commodity management program 75b from the storage section 75 and executing them by the CPU of the control section 71, foregoing each section is loaded on the RAM and implemented in actual hardware.

The member association section 711 associates a member code of a specific customer. The electronic receipt reception section 712 corresponds to the reception module of the present embodiment. The electronic receipt reception section 712 receives the electronic receipt information and the storage location information sent from the electronic receipt management server 4. The display control section 713 corresponds to the display control module of the present embodiment. The display control section 713 generates various GUIs (Graphical User Interfaces) such as a purchased commodity management screen on the basis of the electronic receipt information and the storage location information received by the electronic receipt reception section 712. Further, the display control section 713 controls display of the generated GUIs on the display section 73.

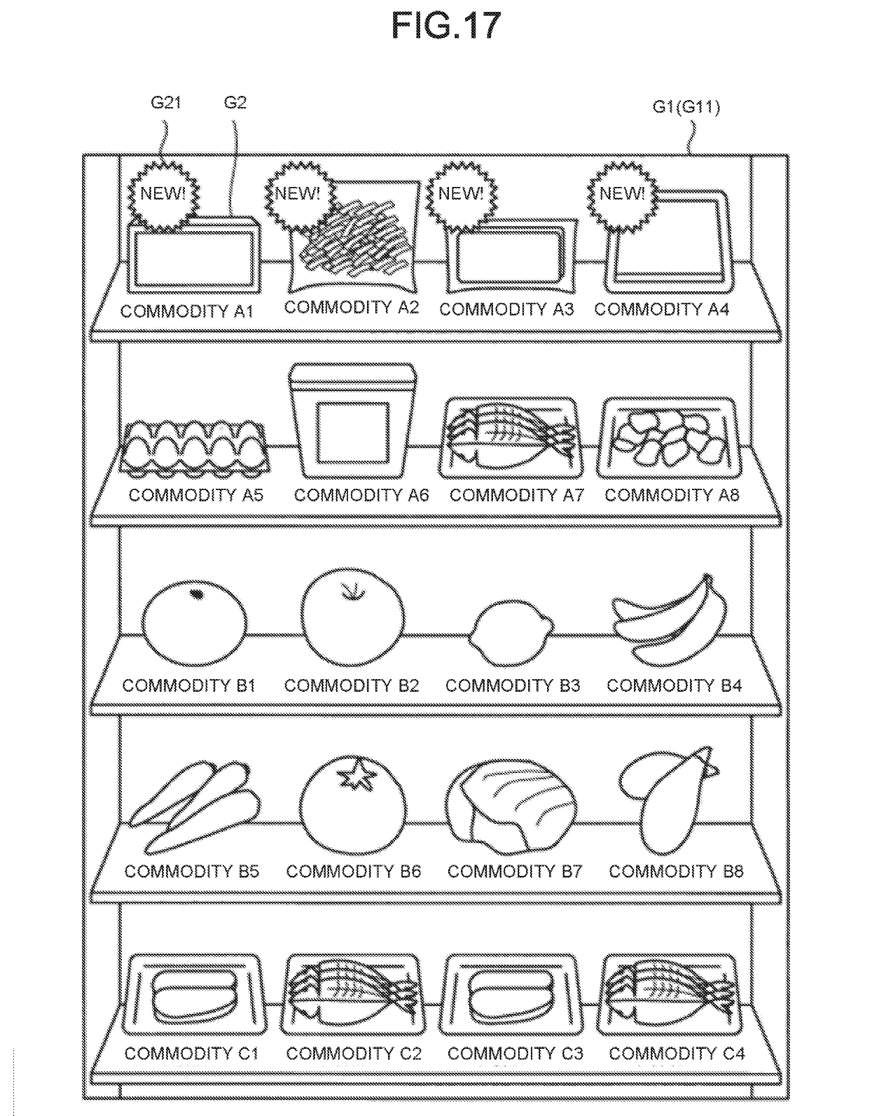

Hereinafter, the GUIs generated and controlled by the display control section 713 are described with reference to FIGS. 17-21

FIGS. 17-19 are diagrams exemplifying the purchased commodity management screen. The purchased commodity management screen G1 is a GUI (Graphical User Interface) for displaying information relating to a commodity purchased by the user of the portable terminal 7 and the storage location information of the commodity. The purchased commodity management screens G1 includes a plurality of commodity images representing each commodity and background images (screens) representing virtual management locations of a commodity. The commodity images are arranged on the background image corresponding to the storage location information respectively as shown in FIGS. 17-19.

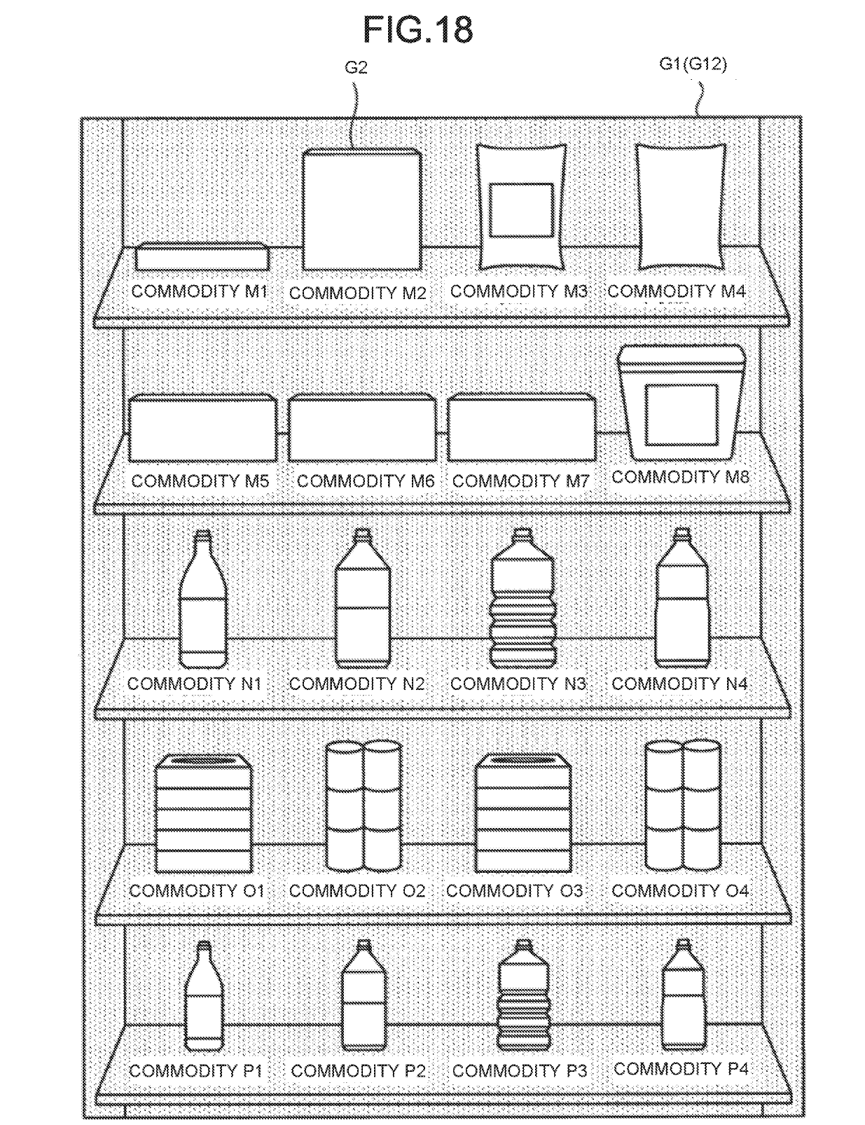

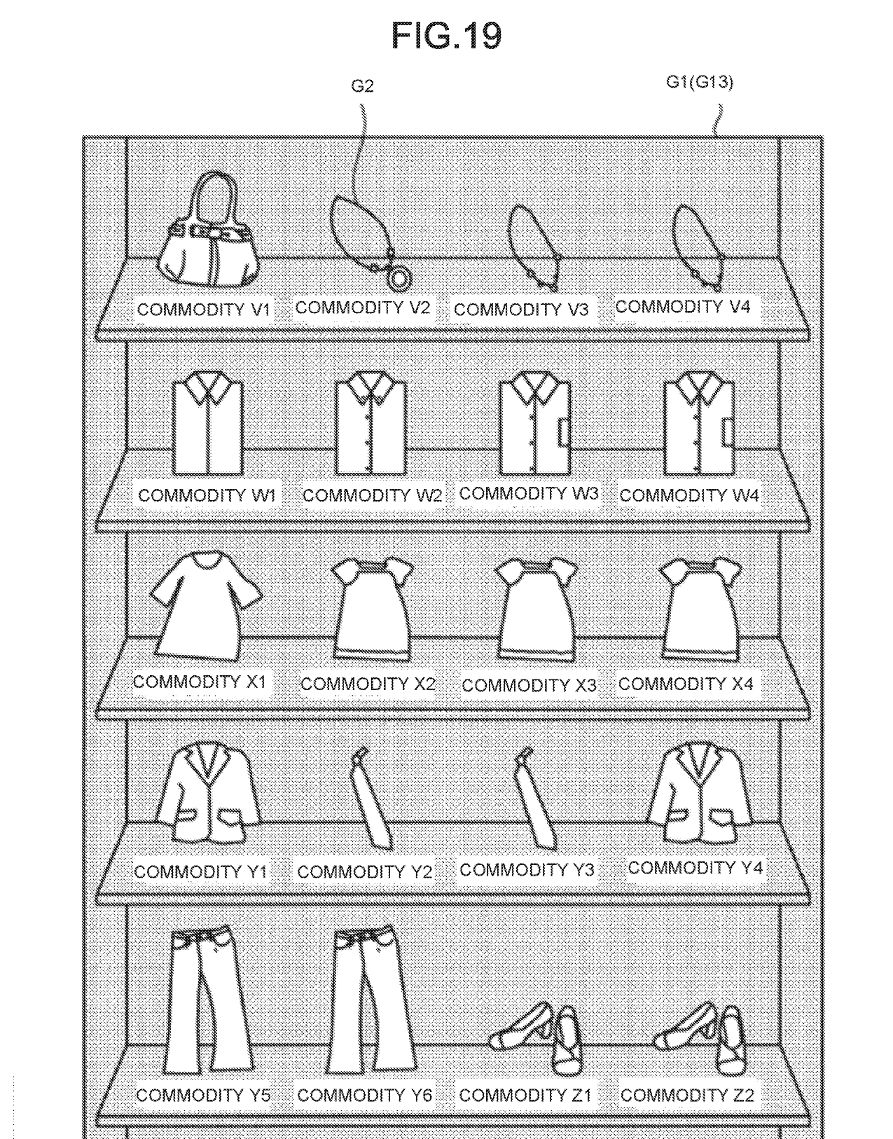

The purchased commodity management screen G11 of FIG. 17 depicts an article storage shelf inside the refrigerator (freeze). The purchased commodity management screen G12 of FIG. 18 depicts an article storage shelf arranged inside a room. Further, the purchased commodity management screen G13 of FIG. 19 depicts a closet. It is assumed that each storage location information indicated by the purchased commodity management screens G1 is associated with each purchased commodity management screens G1. The purchased commodity management screens G1 (which are not limited to the examples of FIGS. 17-19), for example, can add or delete a selected storage destination (purchase management screen).

The display control section 713 arranges a commodity image indicating each commodity (individual commodity sales data D20) contained in the electronic receipt information on the purchased commodity management screen corresponding to the storage location information associated with the commodity. For example, the display control section 713 arranges a commodity image G2 of a commodity for which the storage location information is a “refrigerator” on the purchased commodity management screen G11. The display control section 713 arranges a commodity image G2 of a commodity for which the storage location information is a “stocker” on the purchased commodity management screen G12. Further, the display control section 713 arranges a commodity image G2 of a commodity for which the storage location information is a “closet” on the purchased commodity management screen G13. In this way, as shown in FIGS. 17-19, commodity images G2 are displayed on the purchased commodity management screens G1.

The display control section 713 acquires the commodity image G2 of each commodity from an image data file that stores, for example, a commodity code of each commodity in association with a commodity image of the commodity. Specifically, the display control section 713 reads out a commodity image G2 corresponding to the commodity code from the image data file according to a commodity code of each commodity contained in the electronic receipt information. Then, the display control section 713 arranges the commodity image G2 read out on the purchased commodity management screen G1 on the basis of the storage location information. The image data file may be stored in the portable terminal 7 or in an external device (electronic receipt management server 4, etc.) capable of being accessed by the portable terminal 7.

It is preferred that the storage location of each commodity (storage location information) is associated with a location where the commodity is actually stored. By managing the commodity in this way, as the user of the portable terminal 7 observes the purchased commodity management screen G1 and meanwhile confirms the storage location of the commodity (purchased commodity) purchased by himself/herself, the purchased commodity can be managed efficiently.

(e.g., touch operation) to the commodity image G2, a focus is given to a specific commodity image G2. In this case, the display control section 713, with the use of the individual commodity sales data D20 (extended data D30) and the electronic receipt information relating to the commodity of the selected commodity image G2, generates a commodity details screen illustrating details relating to the commodity. Then, the display control section 713 controls the display section 73 to display generated commodity details screen.

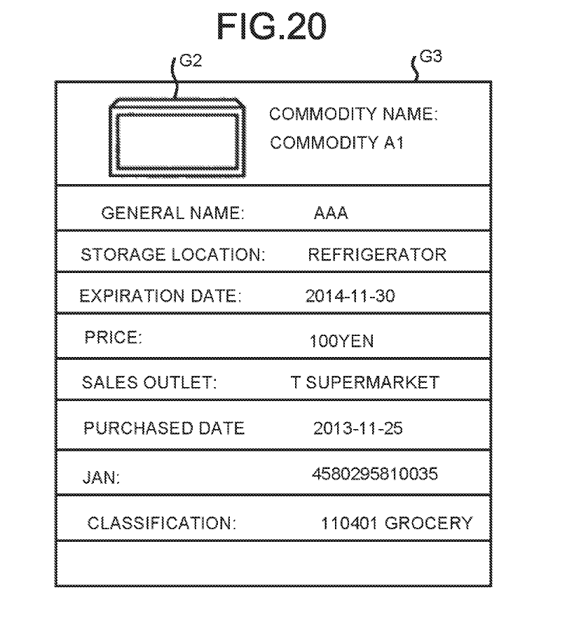

FIG. 20 is a diagram illustrating an example of the commodity details screen G3 about the commodity A1 shown in the purchased commodity management screen G11. As shown in FIG. 20, the commodity details screen G3 has a column for displaying a commodity name, a general name, a storage location, an expiration date, a price, a sales outlet, purchase date, a commodity code (JAN), a classification name and a classification code in addition to the commodity image G2 of the commodity A1. Herein, the commodity name, the price and the commodity code are acquired from the individual commodity sales data D20 of the commodity A1. The general name, the expiration date, the classification name and the classification code are acquired from the extended data D30 of the commodity A1. The storage location is acquired from the storage location information of the commodity A1. Further, the sales outlet and the purchase date are acquired from the electronic receipt information containing the individual commodity sales data D20 of the commodity A1. In the FIG. 20 example, a sales outlet name (T supermarket) is displayed according to the company code and the store code contained in the electronic receipt information.

In this way, in the present embodiment, if a specific commodity is selected from the purchased commodity management screen G1, the detailed information relating to the commodity is displayed as the commodity details screen. Accordingly, the user of the portable terminal 7 can easily confirm the detailed information relating to the purchased commodity, and thus the convenience relating to the management of the purchased commodity can be improved.

The commodity details screen G3, which is not limited to the example of FIG. 20, may be other screen structure or display form. For example, the display control section 713 may display the commodity details screen G3 of the commodity in a pop-up manner in association with the commodity image G2 of the commodity displayed on the purchased commodity management screen G1.

Further, if there is a commodity (individual commodity sales data D20) of which the storage location information is null in the electronic receipt information received by the electronic receipt reception section 712, the display control section 713 extracts the commodity as an unsorted commodity. Then, if an unsorted commodity screen is generated according to the extracted unsorted commodity, the display control section 713 displays the unsorted commodity screen on the display section 73.

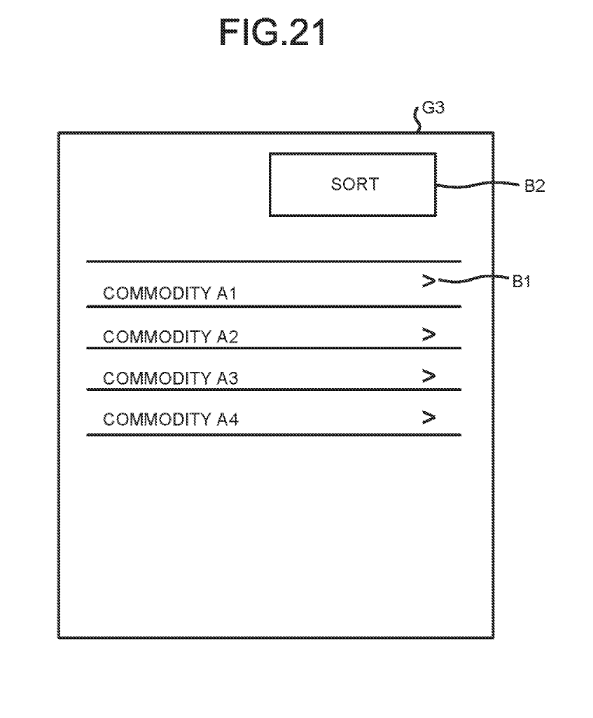

FIG. 21 is a diagram illustrating an example of the unsorted commodity screen. As shown in FIG. 21, information relating to an unsorted commodity for which the storage location information is null (that is, a commodity for which the storage location is not set) is displayed on an unsorted commodity screen G4. A list of commodity names of unsorted commodities is displayed in the example of FIG. 21. A details display button B1 for instructing the display of the above-mentioned commodity details screen G3 and a sorting button B2 for instructing an automatic sorting are arranged on the unsorted commodity screen G4 in association with each of unsorted commodities.

The display control section 713 enables the display section 73 to display the commodity details screen G3 of a corresponding unsorted commodity if an operation to the details display button B1 is received. Herein, the content of the displayed commodity details screen G3 is identical to the screen structure of FIG. 20 described above; however, the item “storage location” is a blank column. The screen structure and the display form of the unsorted commodity screen G4 is not limited to the example of FIG. 21. For example, the display control section 713, at a unit of electronic receipt information, may display a list of unsorted commodities contained in the electronic receipt information.

No specific limitations are given to the display order and the screen transition of the purchased commodity management screen G1 and the unsorted commodity screen G4 described above. For example, the display control section 713 initially enables the display section 73 to display an unsorted commodity screen if there is a commodity for which storage location information is null in the electronic receipt information received by the electronic receipt reception section 712. In this way, is possible for the user to confirm the newly purchased commodity and sorting of the unsorted commodity. Thus, convenience relating to the management of the purchased commodity can be improved. The display control section 713, in response to a swipe operation on the display section 73 may switch and display a plurality of purchased commodity management screens G11-G13 (FIGS. 17-19).

The purchased commodity management section 714 corresponds to a determination module of the present embodiment. The purchased commodity management section 714 cooperates with the display control section 713 to carry out various controls relating to the management of the storage location of each commodity (purchased commodity) contained in the electronic receipt information.

For example, if an operation of pressing the sorting button B2 on the above-mentioned unsorted commodity screen G4 (refer to FIG. 21) is received, the purchased commodity management section 714 carries out a sorting control to determine the storage location of the unsorted commodity based on a sorting condition set in the sorting condition file 75c. Specifically, if the operation of pressing the sorting button B2 is received, the purchased commodity management section 714 retrieves the corresponding sorting condition from the sorting condition file 75c on the basis of the classified information (classification name, classification code, general name, etc.) contained in the extended data D30 of the unsorted commodity. Then, the purchased commodity management section 714, according to the retrieval result, determines the sorting destination of the unsorted commodity in the storage location information of the corresponding sorting condition (automatic sorting). In the automatic sorting process, the purchased commodity management section 714 maintains the determined storage location information locally in association with the individual commodity sales data D20 of the unsorted commodity and meanwhile sends the registration request for the determined storage location information to the electronic receipt management server 4. After the sorting of the unsorted commodity, the corresponding unsorted commodity is regarded as a normal commodity for which the storage location information is set.

If the sorting of the unsorted commodity is carried out through the purchased commodity management section 714, the display control section 713 arranges (adds) the commodity image G2 of this commodity to the purchased commodity management screen G1 corresponding to the storage location information for display. At this time, the display control section 713 emphasizes the commodity image G2 of the newly added commodity.

For example, the commodity A1-A4 are assumed to be newly added on the above-mentioned purchased commodity management screen G11 of FIG. 17. In this case, the display control section 713 displays symbol images G21 indicating that the commodity is newly added in association with these commodity images G2 of commodity A1-A4. In this way, the user of the portable terminal 7 can easily confirm the commodities that are newly added on the purchased commodity management screen G1. Further, the user of the portable terminal 7 can easily maintain a relationship between the purchased commodity management screen G1 and an actual storage location by keeping the commodity added on the purchased commodity management screen G1 in the actual storage location corresponding to the purchased commodity management screen G1.

A method of highlighting the commodity image G2 on the purchased commodity management screen G1 is not limited to the example of FIG. 17. Further, in FIG. 17, display positions of the commodity images G2 of newly added commodities A1-A4 are an uppermost shelf displayed on the purchased commodity management screen G11; however, the present invention is not limited to this. For example, it may be a lowermost shelf. The number of the shelves displayed on the purchased commodity management screen G11 may be variable and added or deleted according to the number of the commodities (commodity images G2).

An arrangement position and an arrangement order of the commodities (commodity images G2) on the purchased commodity management screen G11, which are not specifically limited, may be set every time or may be in a previously displayed form. For example, the commodities (commodity images G2) may be arranged in a sorted sequence or in a sequence of the consumption dates contained in the extended data D30. Further, the user of the portable terminal 7 may alter the arrangement position and the arrangement order of the commodities (commodity images G2) via the operation section 72.

As stated above, the purchased commodity management section 714 carries out the automatic sorting for each of unregistered commodities displayed on the unsorted commodity screen G4 on the basis of the sorting condition according to the operation of pressing the sorting button B2. The automatic sorting, which is not limited to this, may include individually sorting each unregistered commodity. In this case, for example, the sorting button B2 may be arranged in the above-mentioned commodity details screen G3. If the sorting button B2 in the commodity details screen G3 is operated, the purchased commodity management section 714 carries out an automatic sorting of a commodity relating to commodity details screen G3 through the same method stated above.

The purchased commodity management section 714 changes the storage location of each commodity displayed on the purchased commodity management screen G11 to an instructed storage destination if an operation of instructing the change of the storage location is received. For example, the commodity A1 (commodity image G2) in the purchased commodity management screen G11 shown in FIG. 17 is moved into the purchased commodity management screen G12 of FIG. 18 through a drag operation. In this case, the purchased commodity management section 714 changes the storage location information (refrigerator) of commodity A1 to the storage location information (stocker) indicating the purchased commodity management screen G12. The purchased commodity management section 714 sends a registration request instructing the changed storage location information for the commodity A1 serving as the change object to the electronic receipt management server 4.

The manual change of the storage location information by the user operation may be carried out on the unsorted commodity screen G4 or the commodity details screen G3 without being limited on the purchased commodity management screen. For example, in a case in which the unsorted commodity displayed on the unsorted commodity screen G4 is dragged to any purchased commodity management screen G1, the purchased commodity management section 714 sets the storage destination of the unsorted commodity in the storage location information through the drag operation (manual sorting). If an operation of changing the number of shelves at the storage location is received, the purchased commodity management section 714 changes the storage location information of the commodity to a changed storage destination on the commodity details screen G3.

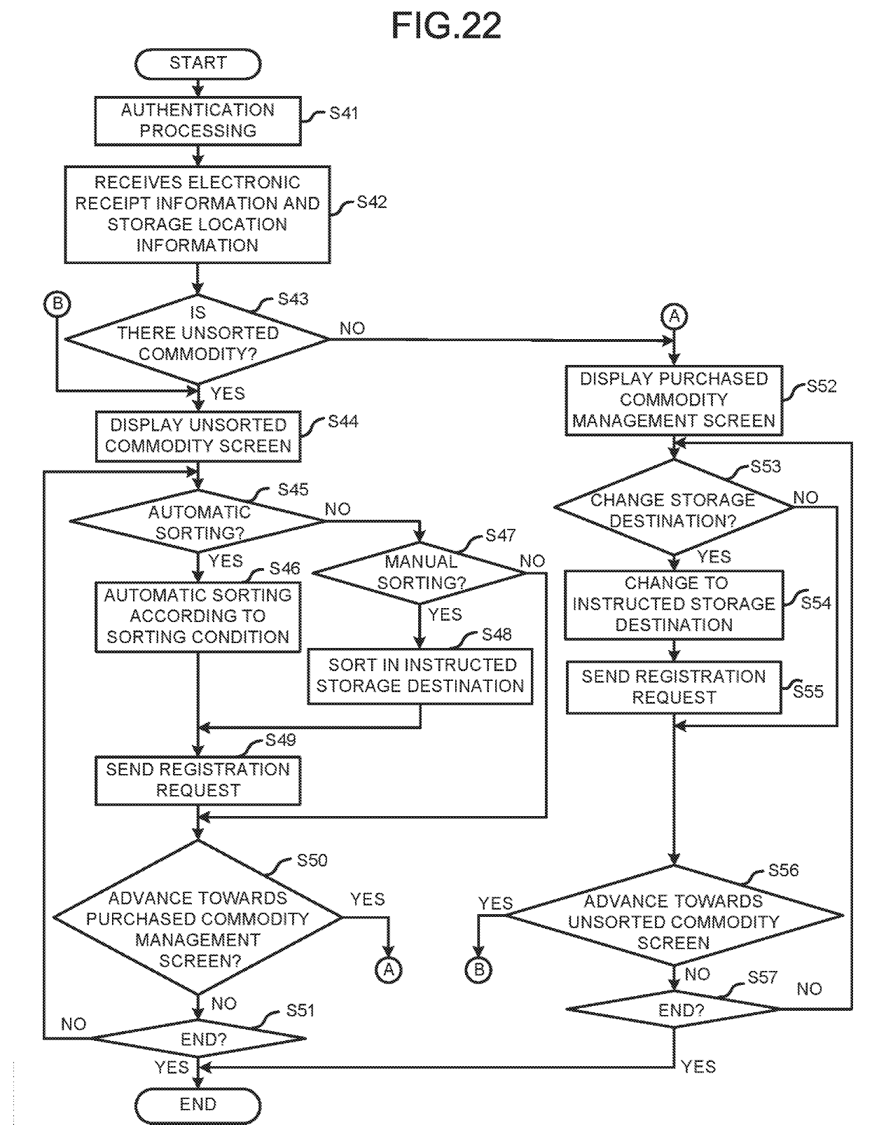

FIG. 22 is a flowchart exemplifying the procedures of the electronic receipt receiving processing and the purchased commodity management processing of the portable terminal 7. As shown in FIG. 22, first, the member association section 711 accesses the electronic receipt management server 4 to execute an authentication processing through the input of the member code and the password (Act S41). In this way, the portable terminal 7 is associated with the member code of a specific customer.

After the authentication processing, the electronic receipt reception section 712 receives the electronic receipt information stored and managed in the electronic receipt management area 43a of the electronic receipt management server 4 together with the storage location information in response to the input member code (Act S42). The electronic receipt information may be received by an e-mail.

Next, the display control section 713 determines whether there is a commodity whose storage location information is null, that is, an unsorted commodity in the electronic receipt information received in Act S42 (Act S43). If there is the unsorted commodity (Yes in Act S43), the display control section 713 displays the unsorted commodity screen G4 (Act S44). If there is no unsorted commodity (No in Act S43), then the display control section 713 proceeds to Act S52.

Herein, through the operation of pressing the sorting button B2, if the automatic sorting of the unsorted commodity is instructed (Yes in Act S45), the purchased commodity management section 714 sorts the storage location information on the basis of the sorting condition (Act S46), and afterwards proceeds to Act S49. The sorting in Act S46 may be executed for all the unsorted commodities displayed on the unsorted commodity screen G4 or for any one of the unsorted commodities.

Through the drag operation of the user, if the manual sorting of the unsorted commodity is instructed (No in Act S45→Yes in Act S47), the purchased commodity management section 714 sorts the storage location information according to the storage destination instructed by the user (Act S48), and afterwards proceeds to Act S49. If neither the automatic sorting nor the manual sorting is instructed (No in Act S45→No in Act S47), the purchased commodity management section 714 proceeds to Act S50.

In Act S49, the purchased commodity management section 714, for the unregistered commodity sorted in Act S46 or Act S48, sends the registration request of the storage location information to the electronic receipt management server 4 (Act S49).

Subsequently, the display control section 713 determines whether an advance towards the purchased commodity management screen G1 is instructed through the user operation (Act S50). In a case in which the advance towards the purchased commodity management screen G1 is not instructed (No in Act S50), the display control section 713 determines whether an instruction of ending the present processing is carried out (Act S51). In a case in which the end of the present processing is not instructed (No in Act S51), the display control section 713 returns to Act S45. Further, in a case in which the end of the present processing is instructed by the user (Yes in Act S51), the display control section 713 closes the unsorted commodity screen G4 to end the present processing. In Act S50, in a case in which the advance towards the purchased commodity management screen G1 is instructed, the display control section 713 proceeds to Act S52.

In Act S52, the display control section 713 displays the purchased commodity management screen G1 (Act S52). As shown in FIG. 17-19, if there are lots of purchased commodity management screens G1, the display control section 713 may display, for example, a predetermined purchased commodity management screen G1 (e.g. the purchased commodity management screen G11). Further, in a case in which the transition to another purchased commodity management screen G1 is instructed, the display control section 713 may switch the purchased commodity management screen G1.

Next, the purchased commodity management section 714 determines whether an instruction of changing the storage destination is carried out for each commodity (commodity image G2) through the user operation (Act S53). If the instruction of changing the storage destination is carried out (Yes in Act S53), the purchased commodity management section 714 changes the storage location information of the commodity to the instructed storage destination (Act S54). Subsequently, the purchased commodity management section 714, for the commodity of which the storage destination is changed in Act S54, sends the registration request of the storage location information to the electronic receipt management server 4 (Act S55) and then proceeds to Act S56. In Act S53, if it is determined that the change of the storage destination is not instructed (No in Act S53), the purchased commodity management section 714 proceeds to Act S56 immediately.

Then, the display control section 713 determines whether an advance towards the unsorted commodity screen G4 is instructed through the operation of the user (Act S56). If the advance towards the unsorted commodity screen G4 is not instructed (No in Act S56), the display control section 713 determines whether an instruction of ending the present processing is carried out (Act S57). Herein, in a case in which the end of the present processing is not instructed (No in Act S57), the display control section 713 returns to Act S53. In a case in which the end of the present processing is instructed by the user (Yes in Act S57), the display control section 713 closes the purchased commodity management screen G1 to end the present processing. Further, in Act S56, in a case in which the advance towards the unsorted commodity screen G4 is instructed, the display control section 713 proceeds to Act S44.

In this way, the portable terminal 7 (electronic receipt reception section 712) of the present embodiment receives the electronic receipt information obtained by adding the extended data (classified information) of the commodity corresponding to the identification information in the printed receipt which at least contains the identification information for identifying the commodity serving as transaction object. Further, the portable terminal 7 (purchased commodity management section 714) determines the storage location of the commodity according to the classified information contained in the electronic receipt information and the sorting condition of the sorting condition file 75c. Then, the portable terminal 7 (display control section 713) displays the storage location of the commodity (purchased commodity management screen G1) and the information (commodity image G2, etc.) relating to the commodity on the display section 73. In this way, as the user of the portable terminal 7 can automatically sort the purchased commodity to the storage location, and the purchased commodity can be managed efficiently. By defining the storage destination suitable to the classification (classified information) of the commodity in the sorting condition file 75c, it is possible to sort each commodity in the storage location suitable to the commodity, and thus the convenience relating to the management of the purchased commodity can be improved.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the foregoing embodiment, the POS terminal 1 stores the extended data file 17d; however, the present invention is not limited to this. For example, an external device such as the store server 2 and the electronic receipt server 3 may store the extended data file 17d, and the POS terminal 1 may access or retrieve the extended data file 17d stored in the external device.

Moreover, in the foregoing embodiment, the control section 11 (data format conversion section 113) of the POS terminal 1 converts the receipt information into the electronic receipt information; however, the present invention is not limited to this. For example, the printer 13 of the POS terminal 1 may execute a conversion processing for converting the receipt information into the electronic receipt information. Specifically, a printing control device (not shown) equipped with the printer 13 for controlling the printing may function as the output control section 112, the data format conversion section 113, the extended data addition section 114 and the electronic receipt output section 115. In this case, the printing control device of the printer 13 prints out the receipt information if it is determined that no member code is contained in the receipt information generated and input by the control section 11 (receipt information generation section 111) of the POS terminal 1. On the other hand, the printing control device of printer 13 converts the receipt information into the electronic receipt information and also adds (appends) the extended data in the electronic receipt information if it is determined that the member code is contained in the receipt information generated and input by the control section 11 (receipt information generation section 111) of the POS terminal 1. Then, the printing control device of the printer 13 sends the generated electronic receipt information to the electronic receipt server 3 via the communication I/F 16 of the POS terminal 1.

In the foregoing embodiment, the control section 11 (extended data addition section 114) of the POS terminal 1 adds the extended data to the electronic receipt information; however, the present invention is not limited to this. For example, the electronic receipt server 3 or the electronic receipt management server 4 may execute a processing of adding the extended data to the electronic receipt information. Specifically, in the POS terminal 1, the electronic receipt output section 115 sends the electronic receipt information generated by the data format conversion section 113 to the electronic receipt server 3 without carrying out the addition of the extended data. On the other hand, a control section of the electronic receipt server 3 or the electronic receipt management server 4 functions as the extended data addition section 114 to execute a processing of adding the extended data to the received electronic receipt information. In this case, after the extended data is added by the extended data addition section 114 of the POS terminal 1, other extended data different from the extended data may be added by the extended data addition section 114 of the electronic receipt server 3 or the electronic receipt management server 4.

Further, in the foregoing embodiment, the electronic receipt management server 4 stores and manages the electronic receipt information; however, the present invention is not limited to this. For example, the electronic receipt server 3 may store and manage the electronic receipt information sent from the POS terminal 1. Specifically, the control section 31 of the electronic receipt server 3 may function as the electronic receipt management section 412 or the electronic receipt sending section 413. In this case, if the electronic receipt information is received from the POS terminal 1, the control section 31 of the electronic receipt server 3 converts the extended data part into an unstructured form, and afterwards stores the converted electronic receipt information in the storage section 33 to be managed. Further, the control section 31 of the electronic receipt server 3, at a predetermined sending timing, if the electronic receipt information stored in the storage section 33 is read out, converts the extended data part into a structured form and then sends the converted electronic receipt information to the electronic receipt management server 4. The control section 31 of the electronic receipt server 3 may send the electronic receipt information of which the extended data part is in an unstructured form to the electronic receipt management server 4. In this case, the control section 41 (electronic receipt management section 412) of the electronic receipt management server 4 may store the electronic receipt information sent from the electronic receipt server 3 in the electronic receipt management area 43a as it is.

Moreover, in the foregoing embodiment, the portable terminal 7 generates a GUI such as the purchased commodity management screen G1, the unsorted commodity screen G4 and the like and then displays it; however, the present invention is not limited to this. For example, the GUI may be generated by the electronic receipt management server 4 side and displayed on the portable terminal 7. Specifically, the control section 41 of the electronic receipt management server 4 may function as the display control section 713 or the purchased commodity management section 714. In this case, if an authentication processing executed by the portable terminal 7 is completed, the control section 41 of the electronic receipt management server 4 generates a GUI such as the purchased commodity management screen G1 and the like according to the electronic receipt information and the storage location information corresponding to the input member code. Then, the control section 41 of the electronic receipt management server 4 provides (sends) the generated GUI to the portable terminal 7 with the use of a Web technology to display the GUI on the display section 73 of the portable terminal 7. The control section 41 of the electronic receipt management server 4 executes the automatic sorting or the manual sorting of the storage location information in response to an operation to the GUI provided to the portable terminal 7.

In the foregoing embodiment, the storage location information is independent from the electronic receipt information; however, the present invention is not limited to this, and the storage location information may be integrated with the electronic receipt information. In this case, for example, the storage location information may be stored as an element of the extended data D30 of each commodity contained in the electronic receipt information. In this case, the element of the storage location information may be contained in the extended data D30 at the stage of the POS terminal 1 or added in the extended data D30 at the stage of the electronic receipt management server 4.

Further, in the foregoing embodiment, a setting content of the sorting condition file 75c is assumed to be a fixed value; however, the present invention is not limited to this, and the setting content may be updated (changed) dynamically. In this case, for example, the purchased commodity management section 714 derives a correlation between the classification (classified information) of the commodity and the storage location according to the past sorting and changes carried out manually by the user. Then, the purchased commodity management section 714 updates the setting (storage location information) of the sorting condition file 75c on the basis of the derived result. In this way, as it is possible to reflect the setting value corresponding to the storage status of each user, and the convenience for the user can be improved.

In the foregoing embodiment, the relationship between the commodity and the storage location information is indicated through the purchased commodity management screen G1; however, the present invention is not limited to this. For example, the identification information of a commodity is associated with the storage location information of the commodity to be displayed in a text-based manner.

In the foregoing embodiment, the member code and the like may be acquired through the code scanner 15; however, the present invention is not limited to this. The member code and the like may be acquired through other method. For example, each of the POS terminal 1 and the portable terminal 7 may be equipped with a short-distance wireless communication section such as a NFC (Near Field Communication) and a Bluetooth (registered trademark) capable of sending and receiving the member code and the like through a short-distance wireless communication. In this case, the portable terminal 7 stores the member code and the like in the storage section 75, an IC tag (not shown) and the like.

In the foregoing embodiment, the member code and the like is acquired from the portable terminal 7; however, the present invention is not limited to this, and the member code and the like may be acquired from a medium such as an IC card and a magnetic card capable of storing the member code. In a case of using the IC card, the POS terminal 1 is provided with a reading/writing section such as an IC card reader/writer. Further, in a case of using the magnetic card, the POS terminal 1 is provided with a card reader/card writer for the magnetic card.

In the foregoing embodiment, each of the POS terminals 1 sends the electronic receipt information to the electronic receipt server 3; however, the present invention is not limited to this. For example, the store server 2 may collect the electronic receipt information generated by the POS terminal 1 in the store P1 and send the collected electronic receipt information to the electronic receipt server 3. Further, the electronic receipt information may be directly sent from the POS terminal 1 to the electronic receipt management server 4.

In the foregoing embodiment, the portable terminal 7 receives the electronic receipt information via the electronic receipt management server 4; however, the present invention is not limited to this. For example, the portable terminal 7 may directly receive the electronic receipt information from the POS terminal 1. In this case, the POS terminal 1 outputs the generated electronic receipt information to the connected portable terminal 7 via the network N1 in the store and a short-distance wireless communication section, and in this case, the authentication processing is carried out by the POS terminal 1.

Programs executed by each device of foregoing embodiment are incorporated into a storage medium (ROM or storage section) of each device to be provided; however, the present invention is not limited to this. For example, the programs may be recorded in a computer-readable recording medium such as a CD-ROM, a FD (Flexible Disk), a CD-R and a DVD (Digital Versatile Disk) in the form of installable or executable file to be provided. Moreover, the recording medium is not limited to a medium independent from a computer or an incorporation system. For example, the recording medium may be a medium for storing or temporarily storing the downloaded programs transferred through an LAN or an internet.

Further, the programs executed by each device of foregoing embodiment may be provided or distributed via a network such as the internet.

What is claimed is:

1. A terminal device, comprising:
a display;
a communication interface configured to receive extended receipt information including a commodity identification data that identifies a commodity subject to a transaction and a classification data for classifying the commodity, wherein the commodity identification data is converted from receipt information generated for printing details of the transaction on a sheet and is received in a different data format than the receipt information, and the classification data is not included in or converted from the receipt information;
a memory that stores the extended receipt information, a commodity image data representing the commodity, and at least one of a plurality of screen data each representing a different possible virtual management location of the commodity; and
a controller configured to
determine a specific virtual management location of the commodity from the different possible virtual management locations based on the classification data,
control the memory to store the determined specific virtual management location of the commodity in association with the extended receipt information, and
control the display to display the commodity image included in a screen based on the screen data corresponding to the determined specific virtual management location of the commodity.

2. The terminal device according to claim 1, wherein
the receipt information has an unstructured format, and
the extended receipt information is received in a structured format.

3. The terminal device according to claim 1, wherein the extended receipt information is transmitted from a server to the terminal device.

4. The terminal device according to claim 3, further comprising:
an interface configured to receive a user input, wherein
if the interface receives an input indicating a specific virtual management location of the commodity, the controller is further configured to control the memory to store the input virtual management location of the commodity in association with the extended receipt information.

5. The terminal device according to claim 3, wherein the server is located remote from a store at which the transaction was performed.

6. The terminal device according to claim 1, wherein the controller is further configured to
identify an unclassified commodity included in the transaction for which no classification information is received, and
control the display to display an operation section to receive an instruction for determining a specific virtual management location of the unclassified commodity.

7. The terminal device according to claim 1, wherein the controller is further configured to control the display to display a plurality of commodities for which the extended receipt information is received based on a sorting instruction.

8. A method of managing commodity information on a terminal device, the method comprising the steps of:
receiving, in the terminal device, extended receipt information including a commodity identification data that identifies a commodity subject to a transaction and a classification data for classifying the commodity, wherein the commodity identification data is converted from receipt information generated for printing details of the transaction on a sheet and is received in a different data format than the receipt information, and the classification data is not included in or converted from the receipt information;
storing, in a memory of the terminal device, the extended receipt information, a commodity image data representing the commodity, and at least one of a plurality of screen data each representing a different possible virtual management location of the commodity;
determining a specific virtual management location of the commodity from the different possible virtual management locations based on the classification data;
storing, in the memory, the determined specific virtual management location of the commodity in association with the extended receipt information; and
displaying, on a display screen of the terminal device, the commodity image included in a screen based on the screen data corresponding to the determined specific virtual management location of the commodity.

9. The method according to claim 8, wherein
the receipt information has an unstructured format, and
the extended receipt information is received in a structured format.

10. The method according to claim 8, wherein the extended receipt information is transmitted from a server to the terminal device.

11. The method according to claim 10, further comprising the steps of:
receiving, in the terminal device, a user input indicating a specific virtual management location of the commodity; and
storing, in the memory of the terminal device, the input virtual management location of the commodity in association with the extended receipt information.

12. The method according to claim 10, wherein the server is located remote from a store at which the transaction was performed.

13. The method according to claim 8, further comprising the steps of:
identifying an unclassified commodity included in the transaction for which no classification information is received; and
displaying, on the display of the display device, an operation section to receive an instruction for determining a specific virtual management location of the unclassified commodity.

14. The method according to claim 8, further comprising the step of:
displaying, on the display device, a plurality of commodities for which the extended receipt information is received based on a sorting instruction.

15. A non-transitory computer readable medium storing instructions causing a terminal device to perform a method of managing commodity information, the method comprising the steps of:
receiving, in the terminal device, extended receipt information including a commodity identification data that identifies a commodity subject to a transaction and a classification data for classifying the commodity, wherein the commodity identification data is converted from receipt information generated for printing details of the transaction on a sheet and is received in a different data format than the receipt information, and the classification data is not included in or converted from the receipt information;
storing, in a memory of the terminal device, the extended receipt information, a commodity image data representing the commodity, and at least one of a plurality of screen data each representing a different possible virtual management location of the commodity;
determining a specific virtual management location of the commodity from the different possible virtual management locations based on the classification data;
storing, in the memory, the determined specific virtual management location of the commodity in association with the extended receipt information; and
displaying, on a display screen of the terminal device, the commodity image included in a screen based on the screen data corresponding to the determined specific virtual management location of the commodity.

16. The non-transitory computer readable medium according to claim 15, wherein
the receipt information has an unstructured format, and
the extended receipt information is received in a structured format.

17. The non-transitory computer readable medium according to claim 15, wherein the extended receipt information is transmitted from a server to the terminal device.

18. The non-transitory computer readable medium according to claim 17, the instructions further causing the terminal device to perform the steps of:
receiving, in the terminal device, a user input indicating a specific virtual management location of the commodity; and
storing, in the memory of the terminal device, the input virtual management location of the commodity in association with the extended receipt information.

19. The non-transitory computer readable medium according to claim 15, the instructions further causing the terminal device to perform the steps of:
identifying an unclassified commodity included in the transaction for which no classification information is received; and
displaying, on the display of the display device, an operation section to receive an instruction for determining a specific virtual management location of the unclassified commodity.

20. The non-transitory computer readable medium according to claim 15, the instructions further causing the terminal device to perform the step of:
displaying, on the display device, a plurality of commodities for which the extended receipt information is received based on a sorting instruction.
